(19) United States
(12) Patent Application Publication
(10) Pub. No.: US 2026/0132850 A1
(43) Pub. Date: May 14, 2026

(54) SYSTEMS, ASSEMBLIES, APPARATUSES, AND METHODS PROVIDING ENHANCED SEAL BETWEEN MACHINE COMPONENTS

(71) Applicant: Vulcan Industrial Holdings, LLC, Houston, TX (US)

(72) Inventors: Richard David Peer, Houston, TX (US); Steven Zachary Newberg, Houston, TX (US); Neerav Verma, Houston, TX (US); Benjamin Scott Berryhill, Houston, TX (US)

(21) Appl. No.: 19/385,240

(22) Filed: Nov. 11, 2025

Related U.S. Application Data
(60) Provisional application No. 63/720,038, filed on Nov. 13, 2024.
(60) Provisional application No. 63/852,220, filed on Jul. 28, 2025.

(51) Int. Cl. F16J 15/00; F16J 15/328; F16J 15/3284

(52) U.S. Cl. CPC F16J 15/002; F16J 15/3284

(57) ABSTRACT

Systems, assemblies, apparatuses, and methods herein may provide an enhanced fluid seal between two machine components. A seal may include a seal body having a seal body surface and a seal cross-section at least partially defined by the seal body surface. The seal body may include a first portion including a first material, the first material having a first coefficient of friction, and a second portion including a second material, the second material having a second coefficient of friction less than the first coefficient of friction, thereby to reduce friction at a seal interface between the second portion of the seal and one of the machine components, so as to reduce heat generation and extend a service life of the seal as the machine component moves relative to another machine component during operation of the machine.

### CROSS REFERENCE TO RELATED APPLICATIONS

This application claims priority to, and the benefit of U.S. Provisional Application No. 63/852,220, filed Jul. 28, 2025, titled “SYSTEMS, ASSEMBLIES, APPARATUSES, AND METHODS PROVIDING ENHANCED FLUID SEAL BETWEEN MACHINE COMPONENTS,” and U.S. Provisional Application No. 63/720,038, filed Nov. 13, 2024, titled “SYSTEMS, ASSEMBLIES, APPARATUSES, AND METHODS PROVIDING ENHANCED FLUID SEAL BETWEEN MACHINE COMPONENTS,” the disclosures of which are incorporated herein by reference in their entirety.

### TECHNICAL FIELD

The present disclosure relates to systems, assemblies, apparatuses, and methods providing an enhanced seal between machine components and, more particularly, to systems, assemblies, apparatuses, and methods providing an enhanced seal between components in high-power machines.

### BACKGROUND

High-power machines often include seals to provide a seal between two or more components of the machine. In some instances, such machine components may include a relatively stationary component and a dynamic component that moves, linearly and/or rotationally, relative to the stationary component. For example, the stationary component may include a housing, cylinder, sleeve, or liner, and the dynamic component may include a rod, piston, or plunger. The seals of high-power machines having such components may often be subjected to increased levels of wear, resulting in frequent maintenance or replacement of the seals.

For example, high-power pumps may be used to transfer a fluid having a first pressure from one location to another location at a second pressure greater than the first pressure. Some types of pumps may be subject to fluctuating interior pressure and elevated temperatures during operation. For example, components of a reciprocating pump may be exposed to fluctuating pressures and elevated temperatures during operation, for example, as plungers reciprocate within a fluid end of the pump.

Pumps may often include a number of seals to prevent fluid from passing from one portion of the pump to another, or from the interior of the pump to the exterior of the pump. An example of such a seal may be used to provide a fluid seal between mating components of the pump. For example, some types of pumps may include various ports that receive another component, and it may be important to provide a fluid seal between the port and the other component. For example, in a reciprocating pump, one or more seals may be provided between a plunger of the pump and a fluid end in which the plunger reciprocates. Some types of pumps, as noted above, may experience relatively large fluctuations in pressure and elevated temperatures, for example, during reciprocation of the plungers. Applicant has recognized that this may result in causing seals in the fluid end to degrade relatively more quickly. The degradation may be particularly pronounced, depending on the contents of the fluid. For example, abrasive particles and/or corrosive fluids may accelerate the degradation of the seals, potentially leading to shortened service lives of the seals, as well as increased downtime, reducing the efficiency of operations using the pump.

An example of a high-power pump includes a pump that may be used to pump fracturing fluid at high pressures and high flow rates during a hydraulic fracturing operation. For example, a hydraulic fracturing operation involves pumping a fracturing fluid at high flow rates and high pressures sufficient to fracture a reservoir formation to allow hydrocarbons to more easily flow from the formation toward a wellbore for production. Such high rates of flow and high pressures may result in significant wear to components associated with the fluid flow, such as high-power pumps used to pump the fracturing fluid. In addition, the fracturing fluid may contain substances, for example, proppants and fluids having abrasive and corrosive characteristics, and thus, seals and components associated with operation of the pumps may exhibit relatively higher wear rates or failure rates. As a result, components associated with pumps, such as seals, may require relatively more frequent maintenance, repair, or replacement, which may increase downtime for the hydraulic fracturing operation and reduce efficiency and productivity. For example, the seals and related components may degrade with use in such harsh conditions, as described above, creating leakage at the seals and related components, which reduces the efficiency and capabilities of the pump.

For at least these reasons, Applicant has recognized that it may be desirable to provide seals, related assemblies, and related methods resulting in relatively longer service lives that reduce downtime associated with use in high-power machines, such as high-power pumps. At least some examples described herein may address one or more of the above-noted potential issues, as well as possibly others.

### SUMMARY

As referenced above, it may be desirable to provide seals, related assemblies, and related methods that result in relatively longer service lives that reduce downtime associated with use in a high-power machine, such as, for example, seals and components used in the oil and gas industry, where the operating conditions and fluids may present a particularly harsh environment. In some embodiments, the systems, assemblies, apparatuses, and methods presented herein may provide a relatively enhanced seal between machine components, such as seals and adjacent components, which may result in relatively reduced damage, deformation, wear, and/or leakage during operation of high-power machines, such as high-power pumps including the seals and components. For example, in some embodiments, the seals and associated components may be configured to reduce or prevent damage, deformation, wear, and/or leakage of the seals and associated components during operation of a high-power pump.

According to some embodiments, a fluid end may include a fluid end block at least partially defining a fluid end bore and a packing recess associated with the fluid end bore. The packing recess may at least partially define a packing recess bore. The fluid end further may include a packing assembly at least partially received in the packing recess bore. The packing assembly may be positioned to enhance a seal between the packing recess and a plunger reciprocating relative to the fluid end block. The packing assembly may include a packing assembly seal having a seal body including a seal body surface and a seal cross-section at least partially defined by the seal body surface. The seal body may include a first portion including a first material, the first material having a first coefficient of friction. The seal body further may include a second portion including a second material, the second material having a second coefficient of friction less than the first coefficient of friction, thereby to reduce friction at a seal interface between the packing assembly seal and the plunger, so as to reduce heat generation and extend a service life of the packing assembly seal as the plunger moves relative to the packing recess. The packing assembly further may include one or more of a lantern ring, a lube seal, an adaptor ring, a pressure ring, or a junk ring.

According to some embodiments, a packing assembly to enhance a seal between a surface of a first component of a fluid end and a surface of a second component of the fluid end may include a packing assembly seal having a seal body including a seal body surface and a seal cross-section at least partially defined by the seal body surface. The packing assembly seal may include one of a header ring, a pressure ring, or a scraper ring, and the seal body may have a first portion including a first material, the first material having a first coefficient of friction. The seal body further may have a second portion including a second material, the second material having a second coefficient of friction less than the first coefficient of friction, thereby to reduce friction at a seal interface between the packing assembly seal and the second component, so as to reduce heat generation and extend a service life of the packing assembly seal as the second component moves relative to the first component. The first component may include a stationary component relative to the second component during operation of the fluid end, and the second component may include one of a reciprocating component or a rotating component relative to the first component during operation of the fluid end. The packing assembly further may include one or more of a lantern ring, a lube seal, an adaptor ring, a pressure ring, or a junk ring.

According to some embodiments, a packing assembly seal to enhance a seal between a surface of a first component of a fluid end and a surface of a second component of the fluid end may include a seal body having a seal body surface and a seal cross-section at least partially defined by the seal body surface. The seal body may include a first portion including a first material, the first material having a first coefficient of friction. The seal body further may include a second portion including a second material, the second material having a second coefficient of friction less than the first coefficient of friction, thereby to reduce friction at a seal interface between the packing assembly seal and the second component, so as to reduce heat generation and extend a service life of the packing assembly seal as the second component moves relative to the first component. The first component may include a stationary component relative to the second component during operation of the fluid end, and the second component may include one of a reciprocating component or a rotating component relative to the first component during operation of the fluid end.

According to some embodiments, a method for enhancing a seal between a surface of a first component of a fluid end and a surface of a second component of the fluid end may include positioning a seal between the surface of the first component and the surface of the second component. The seal may have a seal body including a seal body surface and a seal cross-section at least partially defined by the seal body surface. The seal body may include a first portion including a first material, the first material having a first coefficient of friction. The seal body further may include a second portion including a second material, the second material having a second coefficient of friction less than the first coefficient of friction, thereby to reduce friction at a seal interface between the seal and the second component. The method further may include suppressing generation of heat associated with the seal between the first component and the second component, via the second portion of the seal, during operation of the fluid end as the second component moves relative to the first component.

According to some embodiments, a seal may be provided to enhance a seal between the surface of a first component and the surface of a second component that moves relative to the first component during operation of the machine. The seal may include a seal body having a seal body surface and a seal cross-section at least partially defined by the seal body surface. The seal body may include a first portion and an associated second portion having different coefficients of friction, with the second portion being positioned to provide a seal interface between the first and second components. The coefficient of friction of the second portion may be less than the coefficient of friction of the first portion, thereby to reduce friction at the seal interface between the seal and the second component, so as to reduce heat generation and extend the service life of the seal as the second component moves relative to the first component.

According to some embodiments, a seal to enhance a seal between a surface of a first component of a machine and a surface of a second component of the machine, may include a seal body having a seal body surface and a seal cross-section at least partially defined by the seal body surface. The seal body may include a first portion including a first material, the first material having a first coefficient of friction, and a second portion including a second material, the second material having a second coefficient of friction less than the first coefficient of friction, thereby to reduce friction at a seal interface between the seal and the second component, so as to reduce heat generation and extend a service life of the seal as the second component moves relative to the first component. The first component may include a stationary component relative to the second component during operation of the machine, and the second component may include a reciprocating component and/or a rotating component relative to the first component during operation of the machine.

According to some embodiments, a packing assembly to enhance a seal between a surface of a first component of a machine and a surface of a second component of the machine, may include a packing assembly seal having a seal body including a seal body surface and a seal cross-section at least partially defined by the seal body surface. The seal body may include a first portion including a first material, the first material having a first coefficient of friction, and a second portion including a second material, the second material having a second coefficient of friction less than the first coefficient of friction, thereby to reduce friction at a seal interface between the packing assembly seal and the second component, so as to reduce heat generation and extend a service life of the packing assembly seal as the second component moves relative to the first component. The first component may include a stationary component relative to the second component during operation of the machine, and the second component may include a reciprocating component and/or a rotating component relative to the first component during operation of the machine. The packing assembly further may include one or more of: (a) a lantern ring; (b) a lube seal; (c) an adaptor ring; (d) a pressure ring; or (e) a junk ring.

According to some embodiments, a packing assembly to enhance a seal between a surface of a first component of a pump and a surface of a second component of the pump, may include a header ring having a seal body including a seal body surface and a seal cross-section at least partially defined by the seal body surface. The seal body may include a first portion including a first material, the first material having a first coefficient of friction, and a second portion including a second material, the second material having a second coefficient of friction less than the first coefficient of friction, thereby to reduce friction at a seal interface between the packing assembly seal and the second component, so as to reduce heat generation and extend a service life of the packing assembly seal as the second component moves relative to the first component. The first component may include a stationary component relative to the second component during operation of the machine, and the second component may include a reciprocating component and/or a rotating component relative to the first component during operation of the machine. The packing assembly further may include one or more of: (a) a lantern ring; (b) a lube seal; (c) an adaptor ring; (d) a pressure ring; or (e) a junk ring.

According to some embodiments, a fluid end may include a fluid end block at least partially defining a fluid end bore, a packing recess associated with the fluid end bore, the packing recess at least partially defining a packing recess bore, and a packing assembly at least partially received in the packing recess bore. The packing assembly may be positioned to enhance a seal between the packing recess and a plunger reciprocating relative to the fluid end block. The packing assembly may include a packing assembly seal having a seal body including a seal body surface and a seal cross-section at least partially defined by the seal body surface. The seal body may include a first portion including a first material, the first material having a first coefficient of friction, and a second portion including a second material, the second material having a second coefficient of friction less than the first coefficient of friction, thereby to reduce friction at a seal interface between the packing assembly seal and the plunger, so as to reduce heat generation and extend a service life of the packing assembly seal as the plunger moves relative to the packing recess. The packing assembly further may include one or more of: (a) a lantern ring; (b) a lube seal; (c) an adaptor ring; (d) a pressure ring; or (e) a junk ring.

According to some embodiments, a pump may include a fluid end as described herein, and a power end including a plunger positioned to reciprocate relative to the fluid end.

According to some embodiments, a method for enhancing a seal between a surface of a first component of a machine and a surface of a second component of the machine, may include positioning a seal between the surface of the first component and the surface of the second component, the seal having a seal body having a seal body surface and a seal cross-section at least partially defined by the seal body surface. The seal body may include a first portion including a first material, the first material having a first coefficient of friction, and a second portion including a second material, the second material having a second coefficient of friction less than the first coefficient of friction, thereby to reduce friction at a seal interface between the seal and the second component. The method further may include suppressing generation of heat associated with the seal between a first component and a second component.

According to some embodiments, a method for increasing a service life of a seal for providing a seal between a surface of a first component of a machine and a surface of a second component of the machine, may include positioning a seal between the surface of the first component and the surface of the second component. The seal may have a seal body including a seal body surface and a seal cross-section at least partially defined by the seal body surface. The seal body may include a first portion including a first material, the first material having a first coefficient of friction, and a second portion including a second material, the second material having a second coefficient of friction less than the first coefficient of friction, thereby to reduce friction at a seal interface between the seal and the second component. The method further may include suppressing generation of heat associated with the seal between a first component and a second component.

According to some embodiments, a method for enhancing a seal between a surface of a first component of a pump and a surface of a second component of the pump, may include positioning between the surface of the first component of the pump and the surface of the second component of the pump, a seal having a seal body including a seal body surface and a seal cross-section at least partially defined by the seal body surface. The seal body may include a first portion including a first material, the first material having a first coefficient of friction, and a second portion including a second material, the second material having a second coefficient of friction less than the first coefficient of friction, thereby to reduce friction at a seal interface between the seal and the second component of the pump, so as to reduce heat generation and extend a service life of the seal as the second component of the pump moves relative to the first component.

Still other aspects and advantages of these exemplary embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a schematic side section view of an example high-power machine, including a high-power pump having a fluid end including example seals between example components of the high-power pump, according to embodiments of the disclosure.

FIG. 2A is a schematic side section view of a portion of the example high-power pump shown in FIG. 1, including an example packing assembly, according to embodiments of the disclosure.

FIG. 2B is a schematic side section view of the example packing assembly shown in FIG. 2A, according to embodiments of the disclosure.

FIG. 2C is a schematic partial side section view of the example packing assembly shown in FIG. 2A, according to embodiments of the disclosure.

FIG. 3A is a schematic partial cross-sectional view of an example packing assembly seal, including example first and second portions, according to embodiments of the disclosure.

FIG. 3B is a schematic partial cross-sectional view of the example first portion of the example packing assembly seal shown in FIG. 3A, according to embodiments of the disclosure.

FIG. 3C is a schematic partial cross-sectional view of the example second portion of the example packing assembly seal shown in FIG. 3A, according to embodiments of the disclosure.

FIG. 4A is a schematic partial cross-sectional view of another example packing assembly seal, including example first and second portions, according to embodiments of the disclosure.

FIG. 4B is a schematic partial cross-sectional view of the example first portion of the example packing assembly seal shown in FIG. 4A, according to embodiments of the disclosure.

FIG. 4C is a schematic partial cross-sectional view of the example second portion of the example packing assembly seal shown in FIG. 4A, according to embodiments of the disclosure.

FIG. 5A is a schematic cross-section view of another example packing assembly seal, including example first and second portions, according to embodiments of the disclosure.

FIG. 5B is a schematic cross-section view of still another example packing assembly seal, including example first and second portions, according to embodiments of the disclosure.

FIG. 5C is a schematic cross-section view of yet another example packing assembly seal, including example first and second portions, according to embodiments of the disclosure.

FIG. 5D is a schematic cross-section view of still a further example packing assembly seal, including example first and second portions, according to embodiments of the disclosure.

FIG. 5E is a schematic cross-section view of yet a further example packing assembly seal, including example first and second portions, according to embodiments of the disclosure.

FIG. 6A is a schematic partial cross-sectional view of another example packing assembly seal, including example first and second portions, according to embodiments of the disclosure.

FIG. 6B is a schematic partial cross-sectional view of the example first portion of the example packing assembly seal shown in FIG. 6A, according to embodiments of the disclosure.

FIG. 6C is a schematic partial cross-sectional view of the example second portion of the example packing assembly seal shown in FIG. 6A, according to embodiments of the disclosure.

FIG. 7A is a schematic partial cross-sectional view of an example packing assembly seal, including an example first portion having example fiber-reinforcement, and an example second portion, according to embodiments of the disclosure.

FIG. 7B is a schematic partial cross-sectional view of another example packing assembly seal, including an example first portion having example fiber-reinforcement, an example second portion, and an example seal energizer, according to embodiments of the disclosure.

FIG. 7C is a schematic partial cross-sectional view of a further example packing assembly seal, including an example first portion having example fiber-reinforcement, an example second portion, and an example seal energizer, according to embodiments of the disclosure.

FIG. 7D is a schematic partial cross-sectional view of yet another example packing assembly seal, including an example first portion having example fiber-reinforcement, an example second portion, and example seal energizers, according to embodiments of the disclosure.

FIG. 8A is a schematic partial cross-sectional view of another example packing assembly seal, including an example first portion having a surface with example fiber-reinforcement, and an example second portion, according to embodiments of the disclosure.

FIG. 8B is a schematic partial cross-sectional view of another example packing assembly seal, including an example first portion having a surface with example fiber-reinforcement, an example second portion, and an example seal energizer, according to embodiments of the disclosure.

FIG. 8C is a schematic partial cross-sectional view of a further example packing assembly seal, including an example first portion having a surface with example fiber-reinforcement, an example second portion, and an example seal energizer, according to embodiments of the disclosure.

FIG. 8D is a schematic partial cross-sectional view of yet another example packing assembly seal, including an example first portion having a surface with example fiber-reinforcement, an example second portion, and example seal energizers, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The present disclosure generally is directed to systems, assemblies, apparatuses, and methods that may provide a relatively enhanced seal (e.g., an enhanced fluid seal) between machine components, such as seals and adjacent components, which may result in relatively reduced damage, deformation, wear, and/or leakage during operation of high-power machines, including the seals and components. For example, in some embodiments, the seals and associated components may be configured to reduce or prevent damage, deformation, wear, and/or leakage of the seals and associated components during operation of a high-power pump. Although examples described herein are explained to relation to example high-power pumps and related assemblies and methods, other types of machines are contemplated, such as other high-power machines. For example, embodiments of the systems, assemblies, apparatuses, and methods may be used in other machines, such as, for example, a mud pump, a cement pump, a severe-duty hydraulic cylinder, mining equipment, and/or downhole extensible tooling (e.g., drilling jars, bumper subs, etc.) that are packed for high-pressure, high-cycle applications.

For example, in some embodiments, the seal may have a seal body including one or more portions including different materials, at least one of which materials has a different coefficient of friction as compared to another one of the different materials. As used herein, “coefficient of friction” may refer to static coefficient of friction and/or kinetic coefficient of friction. For example, in some embodiments, a second portion of the seal may have a coefficient of friction less than the coefficient of friction of a first portion of the seal, and a seal interface between the seal and one of the machine components may be provided by the second portion of the seal, thereby to reduce friction at the seal interface between the seal and the one of the machine components, so as to reduce heat generation and extend a service life of the seal as the one of the components moves relative to another of the machine components. For example, a first component may include a stationary component relative to a second component during operation of the machine, and the second component may include a reciprocating and/or rotating component relative to the first component during operation of the machine. For example, during operation of a pump, a reciprocating motion between a plunger and a seal, such as, for example, a packing assembly seal, may result in generation of heat, causing the temperature of the packing assembly seal to increase. In some instances, the increase in temperature may lead to degradation of the packing assembly seal. Applicant has recognized, surprisingly, that by including a portion of the packing assembly seal that forms the seal interface with a moving component having a reduced coefficient of friction, friction at the seal interface between the packing assembly seal and the moving component may be reduced, thereby reducing heat generation at the seal interface, so as to reduce the rate of degradation of the packing assembly seal and extend the useful life of the packing assembly seal. Other types of seals are contemplated.

In some embodiments, the second portion of the seal, which includes the material having a relatively reduced friction, may be formed of a material that deposits a friction-reducing layer of material onto the surface of the moving component, for example, as it reciprocates and/or rotates within the packing assembly, thereby reducing friction and heat generation at the seal interface. For example, the second portion may transfer material to the surface, creating a relatively low friction dynamic surface, thereby effectively reducing friction and heat generation between, for example, some (or all) of the seal rings of the packing assembly and the moving component. For example, as a pump plunger reciprocates, the second portion of the seal, having reduced friction, transfers the material (e.g., such as polytetrafluoroethylene (PTFE)) onto the surface of the plunger (e.g., into to the micro/macro surface imperfections of the plunger), thereby creating a solid lubrication film that reduces the friction between the reciprocating plunger and other rings of the packing assembly, such as, for example, the pressure rings and any grease seals. This reduction of friction reduces the heat generated by the plunger/seal interface, thereby reducing a significant contributor to packing assembly wear and/or failure.

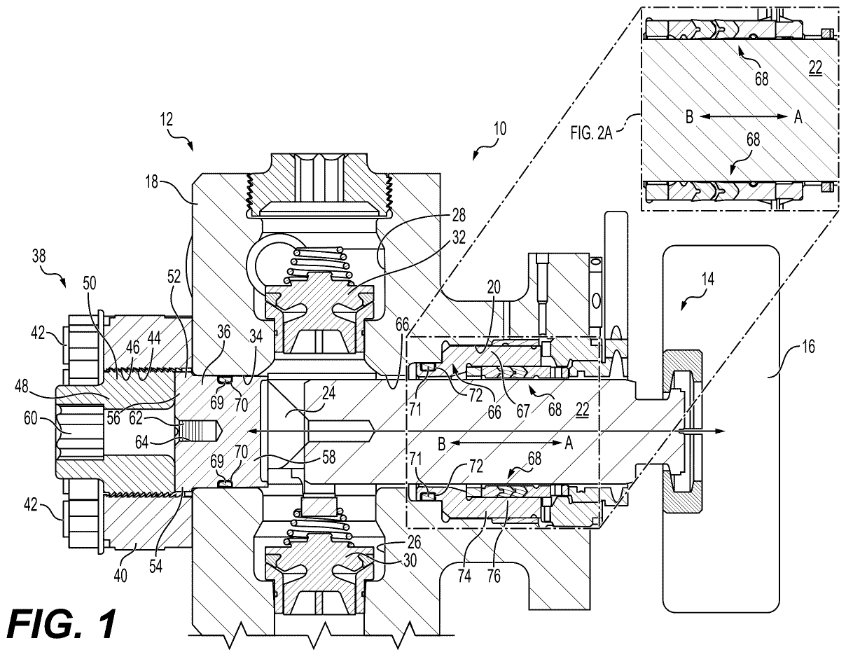

FIG. 1 is a schematic partial side section view of an example machine, an example pump 10, including an example fluid end assembly 12 and an example power end assembly 14, according to embodiments of the disclosure. In some embodiments, the pump 10 may be, for example, a hydraulic fracturing pump for pumping hydraulic fracturing fluid. Although embodiments of the pump 10 are described herein as being a “hydraulic fracturing pump” for pumping hydraulic fracturing fluid for the purpose of discussion, the pump 10 may be any other type of pump, such as, for example, any type of high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping solids, semi-solids, slurries, liquids, fluids, or combinations thereof, such as hydraulic fracturing fluid.

For example, a reciprocating plunger pump may be used to pump a fracturing fluid at high flow rates and high pressures sufficient to fracture a reservoir formation to allow hydrocarbons to more easily flow from the formation toward a wellbore for production. A hydraulic fracturing operation may include as many as six or more hydraulic fracturing units, and each of the hydraulic fracturing units may include a prime mover, such as an electric motor or internal combustion engine, either directly connected, or connected via a transmission, to the reciprocating plunger pump to supply power to drive the reciprocating plunger pump to pump the fracturing fluid into the formation to stimulate production of the well. For example, typical flow rates for a hydraulic fracturing operation may range from about 1,500 to about 4,000 gallons per minute, and typical pressures may range from about 7,500 to about 15,000 pounds per square inch. Although many examples discussed in this disclosure are explained in relation to hydraulic fracturing pumps, such as reciprocating plunger pumps for pumping fracturing fluid and related methods, other flow control-related and/or pumping-related operations, components, and methods are contemplated.

As shown in FIG. 1, the example pump 10 may be a reciprocating plunger pump and may include the fluid end assembly 12 and the power end assembly 14 In some embodiments, the power end assembly 14 may include, for example, a housing 16 with mechanical power transmission components, such as a crankshaft, bearings supporting the crankshaft in the housing, crossheads, reduction gears, and/or connecting rods (e.g., pony rods) and plungers connected to the connecting rods. In some embodiments, the power end assembly 14 may be configured to convert power into reciprocating motion. For example, the power end assembly 14 may be configured to convert rotational power into reciprocating motion, or the power end assembly 14 may be configured to convert electric or hydraulic power into reciprocating motion.

As shown in FIG. 1, the fluid end assembly 12 may include, for example, a fluid end block 18 including one or more fluid end bores 20 (e.g., cylinders) in which respective plungers 22 reciprocate, one or more chambers 24 receiving fluid, one or more suction ports 26 for drawing fluid into the one or more chambers 24, and one or more discharge ports 28 for discharging fluid from the one or more chambers 24 at a higher pressure. For example, as each plunger 22, moved via operation of, for example, a crankshaft and a respective connecting rod of the power end assembly 16, at least partially retracts in direction A into a respective cylinder 20, fluid is drawn into the chamber 24 of the fluid end assembly 12 via the suction port 26 in the fluid end block 18 while a suction valve 30 is open and a discharge valve 32 is closed. As each plunger 22 extends back toward the chamber 24 in direction B, moved via operation of, for example, the crankshaft and the respective connecting rod of the power end assembly 16, pressurized fluid is discharged from the fluid end assembly 12 via the discharge port 28 in the fluid end block 18 while the discharge valve 32 is open and the suction valve 30 is closed. The suction valve 30 and discharge valve 32 may be one-way valves or check valves, allowing fluid to flow only in a single direction, either into the fluid end block 18 via the suction valve 30, or from the fluid end block 18 via the discharge valve 32. In this example manner, the pump 10 draws fluid into the fluid end assembly 12 at a first pressure and discharges the fluid from the fluid end assembly 12 at a higher pressure. In some pump embodiments, the fluid end assembly 12 may include multiple (e.g., two, three, four, or five) sets of suction ports and/or passages, cylinders, plungers, and discharge ports and/or passages to pump fluid at high pressures and/or high flow rates. Other types of pumps, fluid end assemblies, and/or power end assemblies are contemplated.

As shown in FIG. 1, in some embodiments, the fluid end assembly 12 may include an access port 34 providing access to the chamber 24, for example, for use during assembly and/or maintenance of the fluid end assembly 12. The access port 34 may be selectively closed via a cover 36 received in the access port 34. In some embodiments, the access port 34 may be defined in the fluid end block 18 by a circular aperture having an interior face having a substantially cylindrical configuration. In some embodiments, the cover 36 may have a substantially circular cross-section and may have a substantially cylindrical configuration sized and shaped to fit within the interior face of the access port 34, for example, as shown in FIG. 1. In some embodiments, the cover 36 may be sized and shaped to fit snugly within the access port 34.

In some embodiments, a retainer assembly 38 may be used to secure the cover 36 within the access port 34. As shown, in some embodiments, the retainer assembly 38 may include an outer housing 40 configured to be secured to an exterior surface of the fluid end block 18 adjacent the access port 34, for example, via one of more fasteners 42. The outer housing 40 may define a receiver aperture 44 provided with interior retainer threads 46. The retainer assembly 38 further may include a retainer 48, which may include a substantially cylindrical body having exterior retainer threads 50 configured to threadedly engage the interior retainer threads 46 of the outer housing 40. In some embodiments, the cover 36 may include a shoulder 52 and a flange 54 having an exterior end 56 opposite an interior end 58 facing the chamber 24. The shoulder 52 and flange 54 may be configured to abut the exterior surface of the fluid end block 18 adjacent the access port 34. The retainer 48 may be threaded into the outer housing 40 and abut the exterior end 56 of the cover assembly 36, thereby to secure the cover assembly 36 in the access port 34. As shown, in some embodiments, the retainer 48 may include a retainer recess 60 configured to be engaged by a tool for assisting the tightening and loosening of the retainer 48 relative to the outer housing 40 and the cover assembly 36.

As shown in FIG. 1, some embodiments of the cover 36 may include a cover recess 62 opening outward from the center of the exterior end 56 of the cover 36 surface and having interior threads 64. The cover recess 62 may be used to assist within removal of the cover 36, for example, to provide access to the chamber 24. For example, a tool may be used to engage the cover recess 62 (e.g., via the interior threads 64) and assist with pulling the cover 36 from the access port 34.

As shown in FIG. 1, in some embodiments, the fluid end block 18 may include a packing recess 66 in the fluid end bore 20 and at least partially defining a packing recess bore 67. In some embodiments, a packing assembly 68 may be received in the packing recess bore 67 of the packing recess 66, thereby to enhance a fluid seal between the packing recess 66 and a plunger 22 reciprocating relative to the fluid end block 18. The packing recess bore 67 of the packing recess 66 and the packing assembly 68 may be substantially cylindrical, with the packing recess 66 having a substantially circular cross-section and the packing assembly 68 having a substantially cylindrical outer surface received in the packing recess 66. The packing assembly 68 may be configured to at least partially receive therein the plunger 22 as the plunger 22 reciprocates, thereby to draw fluid into the chamber 24 at a first pressure via the suction port 26 during movement of the plunger 22 in the first direction A and discharge the fluid from the chamber 24 at a second pressure greater than the first pressure via the discharge port 28 during movement of the plunger 22 in the second direction B, for example, as shown in FIG. 1. In some embodiments, the packing assembly 68 may be received in the fluid end bore 20, for example, with the fluid end bore 20 being configured to directly receive the packing assembly 68 (e.g., without any intermediate components).

As shown in FIG. 1, a seal 69 (e.g., an annular seal) may be provided between the interior surface of the access port 34 and an exterior surface of the cover 36, thereby to provide a fluid seal between the access port 34 the cover 36 when the cover 36 is received in the access port 34. For example, as shown, the cover 36 may include on the outer cylindrical surface thereof an annular groove 70, and the seal 69 may be at least partially received in the annular groove 70.

As shown in FIG. 1, a seal 71 (e.g., an annular seal) may be provided between the interior surface of the packing recess 66 and an exterior surface of a packing sleeve 74, thereby to provide a fluid seal between the first and second components, for example, the packing recess 66 and the packing sleeve 74, when an end of the packing sleeve 74 is placed in the packing recess 66. For example, as shown, the packing sleeve 74 may include on the outer cylindrical surface thereof an annular groove 72, and the seal 71 may be at least partially received in the annular groove 72.

As shown in FIG. 1, in some embodiments, the packing sleeve 74 may be received in the packing sleeve bore 67 of the fluid end bore 20, and the packing assembly 68 may be received in a packing assembly bore 76 of the packing sleeve 74. The packing assembly 68 may be configured to provide an at least partial fluid seal between the plunger 22 as it reciprocates and the packing sleeve 74, for example, as described herein.

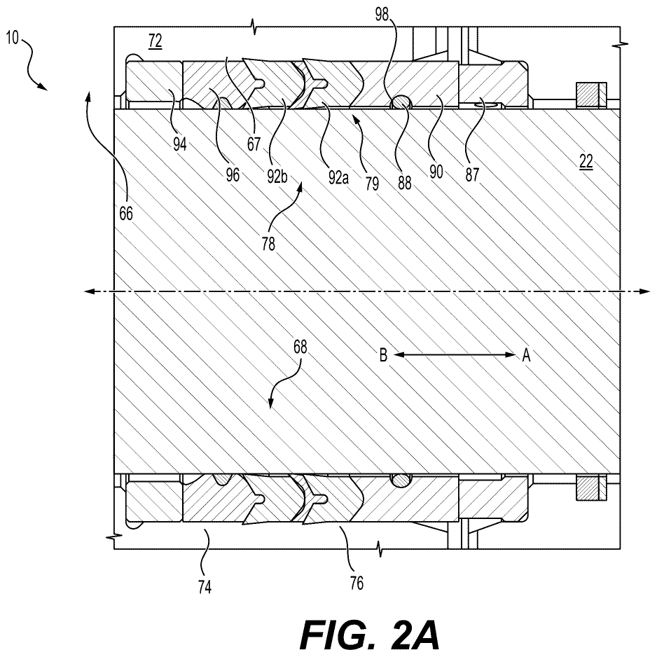

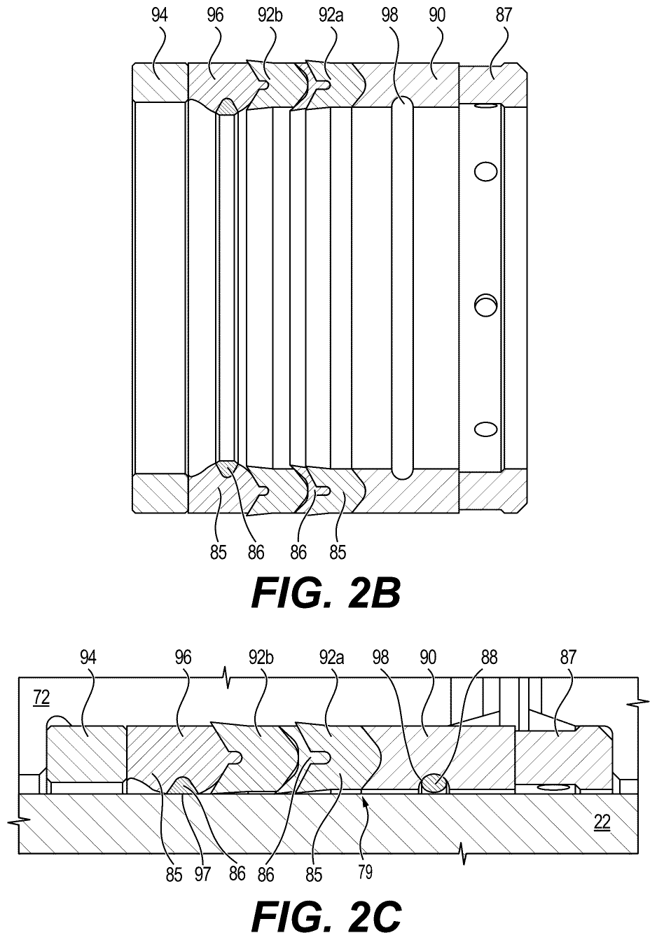

FIG. 2A is a schematic side section view of a portion of the example high-power pump 10 shown in FIG. 1, including an example packing assembly 68, according to embodiments of the disclosure. FIG. 2B is a schematic side section view of the example packing assembly 68 shown in FIG. 2A, according to embodiments of the disclosure, and FIG. 2C is a schematic partial side section view of the example packing assembly 68 shown in FIG. 2A, according to embodiments of the disclosure. As shown in FIGS. 2A-2C, in some embodiments, the packing assembly 68 may be configured to enhance a fluid seal between a surface of a first component of a pump and a surface of a second component of the pump. For example, the packing assembly 68 may include one or more packing assembly seals 78 (e.g., a header ring, a scraper ring, and/or one or more pressure rings). The packing assembly seals 78 may include a seal body 80 having a seal body surface 82 and a seal cross-section 84 at least partially defined by the seal body surface 82. In some embodiments, the seal body 80 may include (or be formed into) an annular seal body. In at least some embodiments, the seal body 80 may include a first portion 85 and a second portion 86, with the second portion 86 being positioned and configured to provide a seal interface 79 between the packing assembly seal 78 and a moving component of the machine, for example, the example plunger 22 of the example pump 10.

In some embodiments, the first portion 85 may include (or be formed of) a first material, with the first material having a first coefficient of friction. The second portion 86 may include (or be formed of) a second material, with the second material having a second coefficient of friction less than the first coefficient of friction, thereby to reduce friction at the seal interface 79 between the packing assembly seal 78 and the second component, so as to reduce heat generation and extend the service life of the packing assembly seal 78 and/or the packing assembly 68, as the second component moves relative to the first component, for example as described herein.

In some embodiments, the packing assembly 68 further may include (a) a lantern ring 87, (b) a lube seal 88, (c) an adaptor ring 90, (d) one or more pressure rings 92 (92a and 92b), and/or (e) a junk ring 94. In some embodiments, the packing assembly seal 78 may include a header ring (or a scraper ring) 96. In some embodiments, the packing assembly seal 78 may include one or more pressure rings 92. For example, the packing assembly 68 may include one or more pressure rings 92 and a junk ring 94, and the packing assembly seal 78 (e.g., the header ring 96) may be positioned between the one or more pressure rings 92 and the junk ring 94, for example, as shown in FIGS. 2A-2C. In some embodiments, the packing assembly 68 may include a header ring 96 and a junk ring 94, and the packing assembly seal 78 (e.g., one or more pressure rings 92) may be positioned between the header ring 96 and the adaptor ring 90, for example, as shown in FIGS. 2A-2C. Other relative orders are contemplated. In some embodiments, a packing retainer nut may be positioned to retain and/or preload the packing assembly 68 relative to the packing assembly bore 76 of the packing sleeve 74, for example, being positioned adjacent and in contact with the lantern ring 87 and, in some embodiments, pressing against the lantern ring 87 and toward the junk ring 94, thereby axially loading the packing assembly 68. In some embodiments, a lube seal (e.g., such as the lube seal 88) may be received in a groove in an inner surface of the packing retainer nut.

In some embodiments, the lantern ring 87 may include (or be formed of) one or more metallic materials, such as bronze, aluminum, or brass, and/or other materials having similar characteristics, such as, for example, thermoplastics, polyamides (e.g., high performance engineering plastics, such as polyether ether ketone (PEEK)), and/or synthetic polymer alloys, such as ORKOT™ (an advanced reinforced medium weave polymer), and/or other composite bearing materials. In some embodiments, the lube seal 88 may include (or be formed of) one or more of an O-ring seal, natural rubber, synthetic rubber, polymeric material, nitriles, fluorocarbon resins, or silicone resins. In some embodiments, the adaptor ring 90 may include (or be formed of) one or more metallic materials, such as bronze, aluminum, or brass, and/or other materials having similar characteristics, such as, for example, thermoplastics, polyamides (e.g., high performance engineering plastics, such as polyether ether ketone (PEEK)), and/or synthetic polymer alloys, such as ORKOT™ (an advanced reinforced medium weave polymer), and/or other composite bearing materials.

In some embodiments, the one or more pressure rings 92 may include (or be formed of) one or more of fabric, composite, nitrile rubber (HNBR), polytetrafluoroethylene (PTFE), thermoplastic polyurethane (TPU), or RESILON™. As described herein, in some embodiments, the one or more pressure rings 92 may include a first portion 85 and a second portion 86. In some embodiments, the first portion 85 may include (or be formed of) one or more of fabric, composite, nitrile rubber (HNBR), polytetrafluoroethylene (PTFE), thermoplastic polyurethane (TPU), or RESILON™, and/or the second portion 86 may include (or be formed of) one or more of polytetrafluoroethylene (PTFE), virgin PTFE, glass-filled PTFE, graphite-filled PTFE, bronze-filled PTFE, moly disulfide-filled PTFE, graphene-filled PTFE, ultra-high-molecular-weight polyethylene (UHMW), UHMW-polyethylene (PE), graphene-filled UHMW, graphene-filled UHMW-PE, carbon nano-tube-filled PTFE, carbon nanotube-filled UHMW, or carbon nanotube-filled UHMW-PE, composite materials having similar functional characteristics, or other materials having similar functional characteristics. In some embodiments, the first portion 85 of the one or more pressure rings 92 may include (or be formed of) a material having a first coefficient of friction, and the first coefficient of friction may range from about 0.11 to about 0.9. Other ranges are contemplated. In some embodiments, the second portion 86 of the one or more pressure rings 92 may be include (or be formed of) a material having a second coefficient of friction, and the second coefficient of friction may range from about 0.01 to about 0.1. Other ranges are contemplated.

In some embodiments, the first coefficient of friction of the first portion 85 may include a first coefficient of static friction and/or a first coefficient of kinetic friction. The second coefficient of friction may include a second coefficient of static friction and/or a second coefficient of kinetic friction. In some embodiments, the second coefficient of static friction and/or the second coefficient of kinetic friction may be less than the first coefficient of static friction and/or the first coefficient of kinetic friction.

In some embodiments, the junk ring 94 may include (or be formed of) one or more one or more metallic materials, such as steel, brass, bronze, or aluminum, composites, and/or other materials having similar characteristics, such as, for example, thermoplastics, polyamides (e.g., high performance engineering plastics, such as polyether ether ketone (PEEK)), and/or synthetic polymer alloys, such as ORKOT™ (an advanced reinforced medium weave polymer), and/or other composite bearing materials. Other materials for one or more of the rings are contemplated.

In some embodiments, the packing assembly seal 78 may include a header ring 96 (and/or a scraper ring), and the packing assembly 68 may include the lantern ring 87, the lube seal 88, the adaptor ring 90, one or more pressure rings 92, and the junk ring 94, for example, as shown in FIGS. 2A-2C. For example, the header ring 96 (and/or a scraper ring) may be positioned between the junk ring 94 and the one or more pressure rings 92, the adaptor ring 90 may be positioned between the one or more pressure rings 92 and the lantern ring 87, and/or the lube seal 88 may be received in a groove 98 of the lantern ring 87 (FIGS. 2A and 2C).

In some embodiments, the header ring 96 may include a first portion 85 and a second portion 86. In some embodiments, the first portion 85 of the header ring 96 may include (or be formed of) a woven metal mesh, a non-woven metal mesh, a metal woven fabric, a metal non-woven fabric, a plurality of layers of metal mesh, a plurality of layers of metal mesh compressed into the seal body 80, a non-woven non-metal mesh, a woven non-metal mesh, a woven non-metal fabric, a non-woven non-metal fabric, polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), thermoplastic polyurethane (TPU), or RESILON™, or polyurethan. In some embodiments, the first portion 85 of the header ring 96 may include (or be formed of) metal mesh, and the metal mesh may include one or more of aluminum, aluminum alloy, brass, brass alloy, bronze, bronze alloy, silver, silver alloy, copper, copper alloy, steel, or steel alloy. In some embodiments, the second portion 86 of the header ring 96 may include (or be formed of) one or more of polytetrafluoroethylene (PTFE), virgin PTFE, glass-filled PTFE, graphite-filled PTFE, bronze-filled PTFE, moly disulfide-filled PTFE, graphene-filled PTFE, ultra-high-molecular-weight polyethylene (UHMW), UHMW-polyethylene (PE), graphene-filled UHMW, graphene-filled UHMW-PE, carbon nano-tube-filled PTFE, carbon nanotube-filled UHMW, carbon nanotube-filled UHMW-PE, composite materials having similar functional characteristics, or other materials having similar functional characteristics. In some embodiments, the first portion 85 of the header ring 96 (or scraper ring) may include (or be formed of) a material having a first coefficient of friction, and the first coefficient of friction may range from about 0.11 to about 0.9. Other ranges are contemplated. In some embodiments, the second portion 86 of the header ring 96 (or scraper ring) may be include (or be formed of) a material having a second coefficient of friction, and the second coefficient of friction may range from about 0.01 to about 0.1. Other ranges are contemplated.

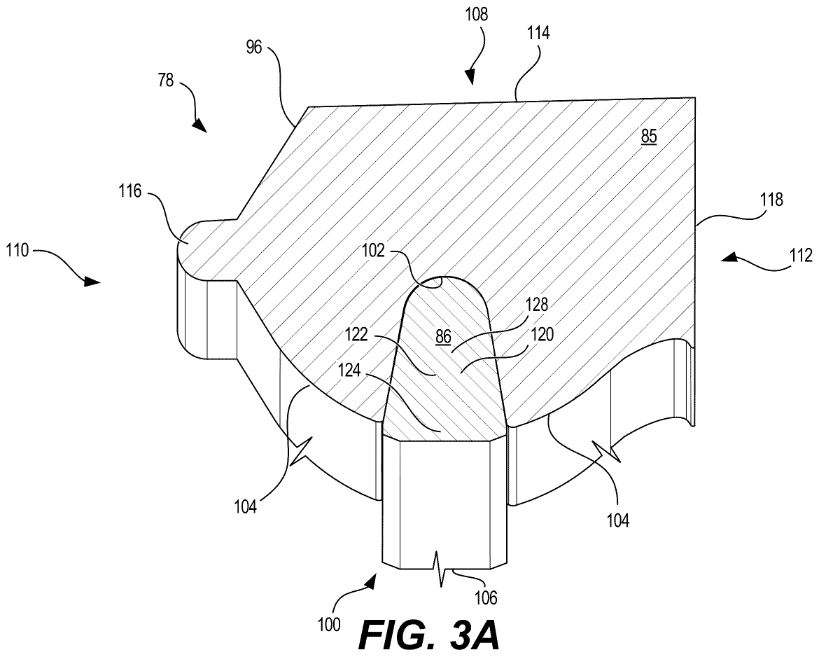

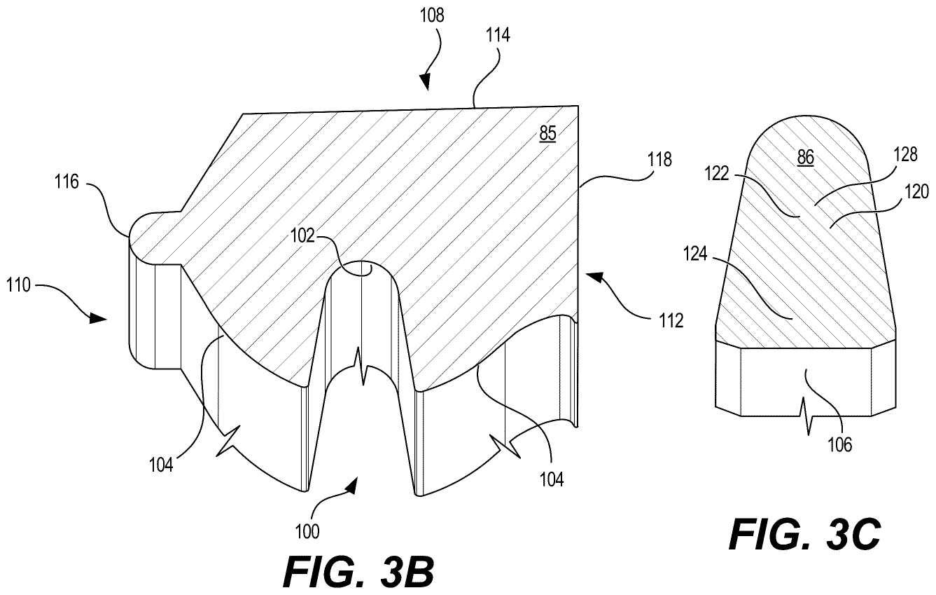

FIG. 3A is a schematic partial cross-sectional view of an example packing assembly seal 78 (e.g., a header ring 96), including example first and second portions 85 and 86, according to embodiments of the disclosure. FIG. 3B is a schematic partial cross-sectional view of the example first portion 85 of the example packing assembly seal 78 shown in FIG. 3A, according to embodiments of the disclosure, and FIG. 3C is a schematic partial cross-sectional view of the example second portion 86 of the example packing assembly seal 78 shown in FIG. 3A, according to embodiments of the disclosure. As shown in FIGS. 3A-3C, in some embodiments, the first portion 85 of the packing assembly seal 78 may include an inward facing surface 100 (e.g., a radially inward facing surface), and may at least partially define a recess 102 (e.g., an annular recess) in the inward facing surface 100 of the first portion 85. In some embodiments, the second portion 86 of the packing assembly seal 78 may be at least partially received in the recess 102 in the inward facing surface 100 of the first portion 85. In some embodiments, the inward facing surface 100 of the first portion 85 may be substantially convex and/or may at least partially define a curved surface 104. The second portion 86 may include an inward facing surface 106 (e.g., a radially inward facing surface), and the inward facing surface 106 of the second portion 86 may project inward relative to the curved surface 104 of the inward facing surface 100 of the first portion 85, for example, such that the inward facing surface 106 of the second portion 86 projects radially inward beyond a continuation of the curved surface 104 of the inward facing surface 100 of the first portion 85, for example, as shown. In some embodiments, the second portion 86 may include the inward facing surface 106, and the inward facing surface 106 of the second portion 86 may be positioned at the seal interface 79 between the packing assembly seal 78 and the second component (e.g., a plunger of a pump).

As shown in FIGS. 3A-3C, in some embodiments, the seal cross-section 84 may include the inward facing surface 100 at least partially defined by the second portion 86, and an outward facing surface 108 (e.g., a radially outward facing surface) substantially opposite the inward facing surface 106. The outward facing surface 108 may be at least partially defined by the first portion 85. The seal cross-section 84 may further include a first axial end surface 110 at least partially defined by the first portion 85, and a second axial end surface 112 substantially opposite the first axial end surface 110. The second axial end surface 112 may be at least partially defined by the first portion 85. In some embodiments, as shown in FIGS. 3A-3C, for example, the inward facing surface 100 may include a substantially convex portion at least partially defined by the first portion 85, and the outward facing surface 108 may include a substantially planar portion 114 at least partially defined by the first portion 85. In some embodiments, the first axial end surface 110 may at least partially define a protrusion 116 at least partially defined by the first portion 85, and/or the second axial end surface 112 may at least partially define a substantially planar portion 118 at least partially defined by the first portion 85.

In some embodiments, the first portion 85 and the second portion 86 may be molded together to form a single-piece integrated seal body 80 (e.g., a single-piece integrated annular seal body). In some embodiments, the first portion 85 and the second portion 86 may be co-extruded and formed into the seal body 80. In some embodiments, the first portion 85 and the second portion 86 may be formed separately and secured to one another to form a single-piece integrated seal body 80. In some embodiments, the first portion 85 and the second portion 86 may be secured to one another via, for example, compression, welding, friction welding, adhesive, and/or mechanical engagement. Other methods of forming the packing assembly seal 78 are contemplated.

As shown in FIGS. 3A-3C, in some embodiments, the second portion 86 may include a second portion body 120 (e.g., an annular second portion body) having a second portion cross-section, and the second portion cross-section may include a stem 122 and a head 124 connected to the stem 122, with the head 124 being enlarged relative to the stem 122. For example, the first portion 85 may at least partially define the recess 102, and the second portion 86 may be at least partially received in the recess 102 of the first portion 85. For example, the stem 122 may be received in the recess 102, and the head 124 may at least partially protrude from the recess 102, for example, as shown. In some embodiments, the stem 12 may transition smoothly into the head 124, for example, as show in FIGS. 3A-3B.

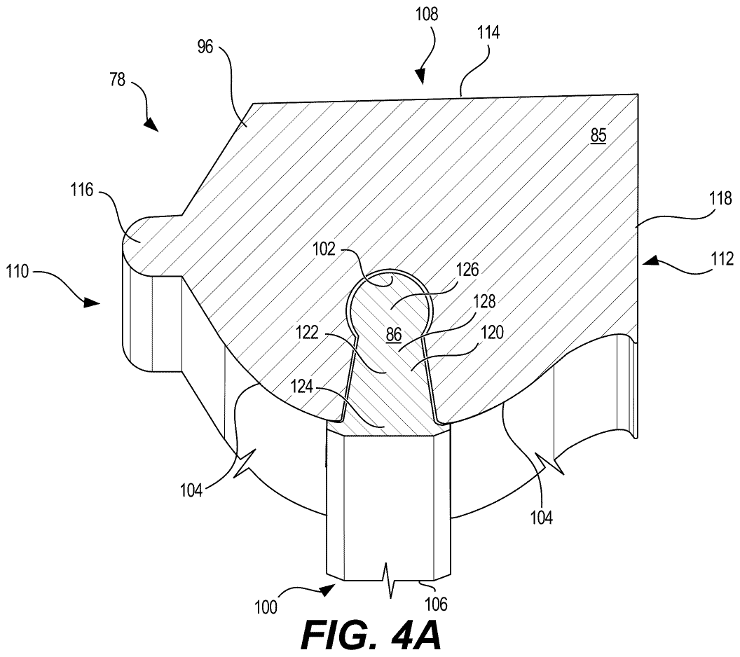

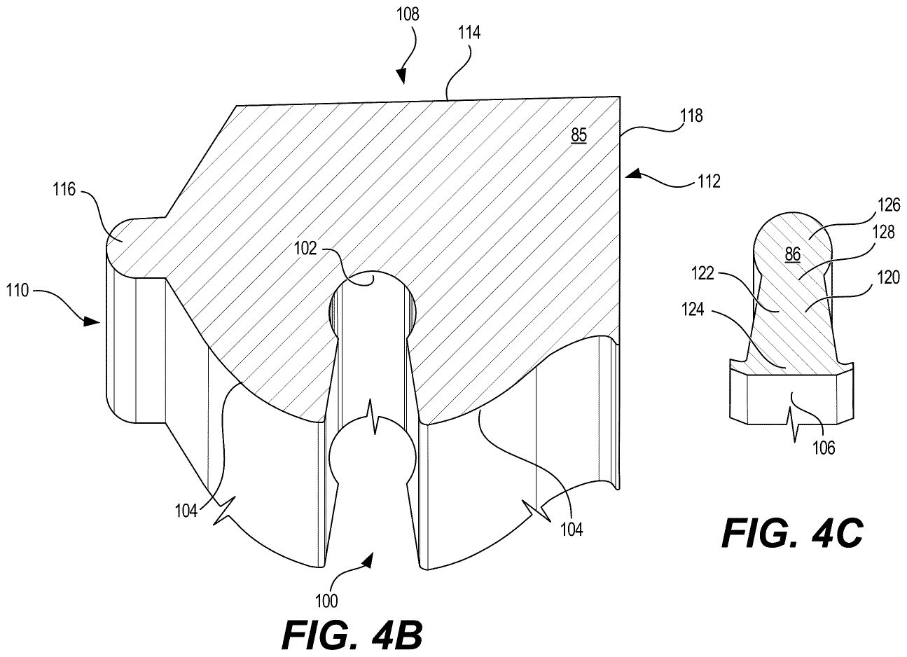

FIG. 4A is a schematic partial cross-sectional view of another example packing assembly seal 78, including example first and second portions 85 and 86, according to embodiments of the disclosure. FIG. 4B is a schematic partial cross-sectional view of the example first portion 85 of the example packing assembly seal 78 shown in FIG. 4A, according to embodiments of the disclosure, and FIG. 4C is a schematic partial cross-sectional view of the example second portion 86 of the example packing assembly seal 78 shown in FIG. 4A, according to embodiments of the disclosure. As shown in FIGS. 4A-4C, in some embodiments, the stem 122 may at least partially define a bulb 126 and a neck 128 between the head 124 and the bulb 126, with the neck 128 having a reduced thickness relative to one or more of the bulb 126 or the head 124. In some embodiments, the head 124 of the second portion 86 may be substantially mushroom-shaped in cross-section, for example, as shown in FIGS. 4A-4B. In some embodiments, the second portion cross-section is bilaterally symmetric, for example, relative to the stem 122 of the second portion 86 (see, e.g., FIGS. 3C, 4C, and 6C). Other cross-sectional shapes of the second portion 86 are contemplated, and the first portion 85 may be configured to provide a complimentary recess for receiving at least a portion of the second portion 86.

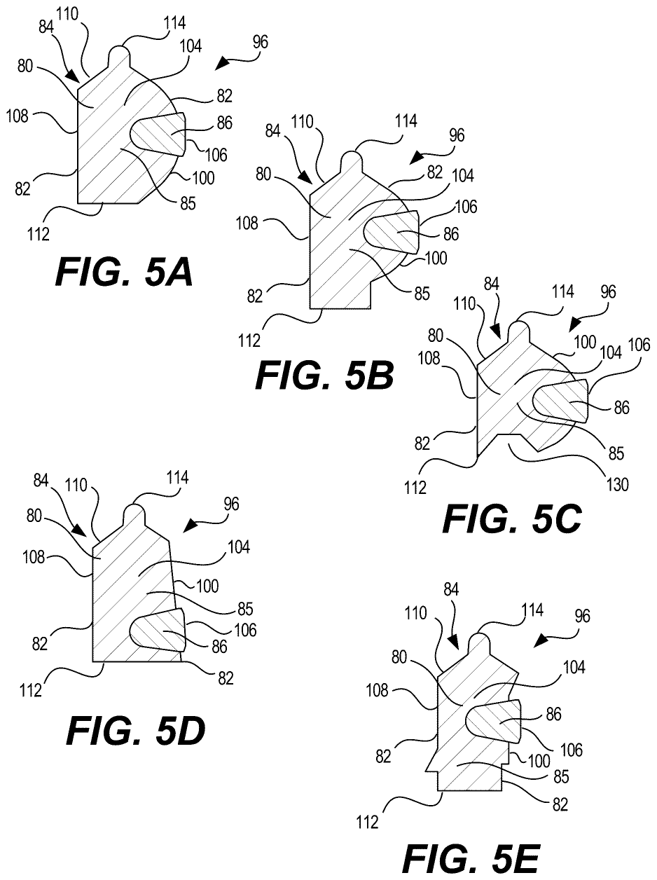

FIGS. 5A, 5B, 5C, 5D, and 5E are schematic cross-section views of example packing assembly seals 78 having respective seal cross-sections 84, according to embodiments of the disclosure. As shown in FIGS. 5A-5E, the seal body 80 may have different seal cross-sections 84. In some embodiments, the seal cross-sections 84 may include one or more of (a) a radially inward facing surface 100 (e.g., a radially inward facing surface), (b) an outward facing surface 108 (e.g., a radially outward facing surface) substantially opposite the inward facing surface 100, (c) a first axial end surface 110, or (d) a second axial end surface 112 substantially opposite the first axial end surface 110. In some embodiments, the inward facing surface 100 may include a substantially convex portion (see, e.g., FIGS. 5A-5C). In some embodiments, the outward facing surface 108 may include a substantially planar portion (see, e.g., FIGS. 5A-5E). In some embodiments, the first axial end surface 110 may at least partially define a protrusion 116 (see, e.g., FIGS. 5A-5E). In some embodiments, the second axial end surface 112 may at least partially define a recess 130 (see, e.g., FIG. 5C). As shown in FIGS. 5A-5E, various seal cross-section 84 shapes are contemplated.

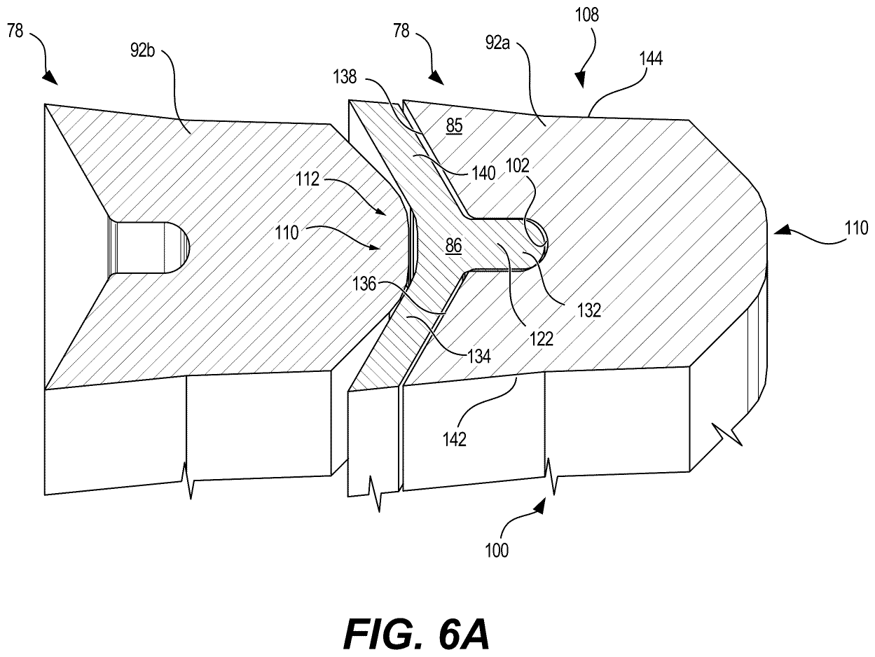

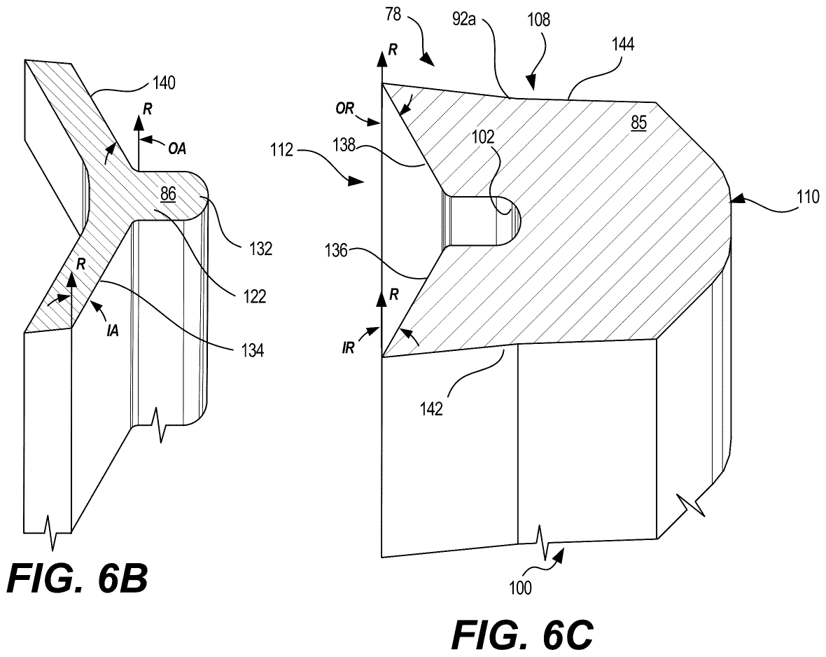

FIG. 6A is a schematic partial cross-sectional view of another example packing assembly seal 78, including an example first pressure ring 92a including example first and second portions 85 and 86, and an example second pressure ring 92b, according to embodiments of the disclosure. FIG. 6B is a schematic partial cross-sectional view of the example first portion 85 of the example packing assembly seal 78 shown in FIG. 6A, according to embodiments of the disclosure, and FIG. 6C is a schematic partial cross-sectional view of the example second portion 86 of the example packing assembly seal 78 shown in FIG. 6A, according to embodiments of the disclosure. As shown in FIGS. 6A-6C, for example, the packing assembly seal 78 may include a first pressure ring 92a including a first portion 85 and a second portion 86, as well as a second pressure ring 92b. As described herein, and at least similar to embodiments shown in FIGS. 3A-4C, in some embodiments of the pressure ring 92, the first portion 85 may include (or be formed of) a first material, with the first material having a first coefficient of friction. The second portion 86 may include (or be formed of) a second material, with the second material having a second coefficient of friction less than the first coefficient of friction, thereby to reduce friction at the seal interface 79 between the packing assembly seal 78 (the first pressure ring 92a) and the second component, so as to reduce heat generation and extend the service life of the packing assembly seal 78 and/or the packing assembly 68, as the second component (e.g., a plunger of a pump) moves relative to the first component, for example as described herein. In some embodiments, the second pressure ring 92b may include a construction and/or configuration at least similar to the first pressure ring 92a.

In some embodiments, as shown in FIGS. 6A-6C, the first portion 85 of the pressure ring 92a may include a first axial end surface 110 and a second axial end surface 112 substantially opposite the first axial end surface 110, the second axial end surface 112 at least partially defining an axial recess 102 (e.g., an axial annular recess). The second portion 86 of the pressure ring 92a may be at least partially received in the axial recess 102 in the second axial end surface 112 of the first portion 85. For example, the second axial end surface 112 of the first portion 85 may be substantially concave and may extend between an inward facing surface 100 (e.g., a radially inward facing surface) of the first portion and an outward facing surface 108 (e.g., a radially outward facing surface) of the first portion 85. The axial recess 102 may be positioned between the inward facing surface 100 of the first portion 85 and the outward facing surface 108 of the first portion 85, and the second portion 86 may include a second portion protrusion 132 at least partially received in the axial recess 102 of the first portion 85.

As shown in FIGS. 6A-6C, in some embodiments, the second portion 86 may include an inward extending arm 134 (e.g., a radially inward extending arm) connected to the second portion protrusion 132, with the inward extending arm 134 being positioned to bias the inward facing surface 100 of the first portion 85 inward (e.g., radially inward) against a moving component. The second axial end surface 112 of the first portion 85 may include an inner ramp surface 136 extending between the axial recess 102 of the first portion 85 and the inward facing surface 100 of the first portion 85. The inner ramp surface 136 may lie at an inner ramp angle IR relative to a radial axis R of the packing assembly seal 78. In some embodiments, the inward extending arm 134 may at least partially define an inner arm angle IA relative to the radial axis R of the packing assembly seal 78. The inner arm angle IA may be less than or equal to the inner ramp angle IR, for example, to bias the inward facing surface 100 of the first portion 85 radially inward.

In some embodiments, the second axial end surface 112 of the first portion 85 may include an outer ramp surface 138 extending between the axial recess 102 of the first portion 85 and the outward facing surface 100 of the first portion 85. The outer ramp surface 138 may lie at an outer ramp angle OR relative to the radial axis R of the packing assembly seal 78. An outward extending arm 140 (e.g., a radially outward extending arm) may at least partially defines an outer arm angle OA relative to the radial axis R of the packing assembly seal 78. In some embodiments, the outer arm angle OA may be less than or equal to the outer ramp angle OR, for example, to bias the outward facing surface 108 of the first portion 85 outward (e.g., radially outward). In some embodiments consistent with FIGS. 6A-6C, the second portion cross-section of the second portion 86 may be bilaterally symmetric relative to the stem 122 of the second portion 86.

As shown in FIGS. 6A-6C, in some embodiments, the seal cross-section 84 may include an inward facing surface 100 at least partially defined by the first portion 85, an outward facing surface 108 substantially opposite the inward facing surface 100, with the outward facing surface 108 being at least partially defined by the first portion 85. The seal cross-section 84 further may include a second axial end surface 112 at least partially defined by the second portion 86, and the seal cross-section 84 may include a first axial end surface 110 substantially opposite the second axial end surface 112 of the packing assembly seal, with the first axial end surface 110 being at least partially defined by the first portion 85. The inward facing surface 100 may include a substantially planar portion 142 at least partially defined by the first portion 85, the outward facing surface 112 may include a substantially planar portion 144 at least partially defined by the first portion 85, the first axial end surface 110 of the packing assembly seal 78 may be at least partially defined by the first portion 85 and may be at least partially convex, and/or the second axial end surface 112 of the packing assembly seal 78 may be at least partially defined by the second portion 86 and may be at least partially concave. Some such embodiments may facilitate nesting of the first axial end surface 110 of the second pressure ring 92b in the at least partially concave portion of the second portion 86, for example, as shown in FIG. 6A.

In some embodiments, the one or more pressure rings 92 may include (or be formed of) one or more of fabric, composite, nitrile rubber (HNBR), polytetrafluoroethylene (PTFE), thermoplastic polyurethane (TPU), or RESILON™. As described herein, in some embodiments, the one or more pressure rings 92 may include a first portion 85 and a second portion 86. In some embodiments, the first portion 85 may include (or be formed of) one or more of fabric, composite, nitrile rubber (HNBR), polytetrafluoroethylene (PTFE), thermoplastic polyurethane (TPU), or RESILON™, and/or the second portion 86 may include (or be formed of) one or more of polytetrafluoroethylene (PTFE), virgin PTFE, glass-filled PTFE, graphite-filled PTFE, bronze-filled PTFE, moly disulfide-filled PTFE, graphene-filled PTFE, ultra-high-molecular-weight polyethylene (UHMW), UHMW-polyethylene (PE), graphene-filled UHMW, graphene-filled UHMW-PE, carbon nano-tube-filled PTFE, carbon nanotube-filled UHMW, carbon nanotube-filled UHMW-PE, composite materials having similar functional characteristics, or other materials having similar functional characteristics. In some embodiments, the first portion 85 of the one or more pressure rings 92 may include (or be formed of) a material having a first coefficient of friction, and the first coefficient of friction may range from about 0.11 to about 0.9. Other ranges are contemplated. In some embodiments, the second portion 86 of the one or more pressure rings 92 may be include (or be formed of) a material having a second coefficient of friction, and the second coefficient of friction may range from about 0.01 to about 0.1. Other ranges are contemplated.

In some embodiments, the first coefficient of friction of the first portion 85 may include a first coefficient of static friction and/or a first coefficient of kinetic friction. The second coefficient of friction may include a second coefficient of static friction and/or a second coefficient of kinetic friction. In some embodiments, the second coefficient of static friction and/or the second coefficient of kinetic friction may be less than the first coefficient of static friction and/or the first coefficient of kinetic friction.

In some embodiments, the first portion 85 of the pressure ring 92 may include (or be formed of) metal mesh, and the metal mesh may include one or more of aluminum, aluminum alloy, brass, brass alloy, bronze, bronze alloy, silver, silver alloy, copper, copper alloy, steel, or steel alloy. In some embodiments, the second portion 86 of the pressure ring 92 may include (or be formed of) one or more of polytetrafluoroethylene (PTFE), virgin PTFE, glass-filled PTFE, graphite-filled PTFE, bronze-filled PTFE, moly disulfide-filled PTFE, graphene-filled PTFE, ultra-high-molecular-weight polyethylene (UHMW), UHMW-polyethylene (PE), graphene-filled UHMW, graphene-filled UHMW-PE, carbon nano-tube-filled PTFE, carbon nanotube-filled UHMW, carbon nanotube-filled UHMW-PE, composite materials having similar functional characteristics, or other materials having similar functional characteristics. In some embodiments, the first portion 85 of the pressure ring 92 may include (or be formed of) a material having a first coefficient of friction, and the first coefficient of friction may range from about 0.11 to about 0.9. Other ranges are contemplated. In some embodiments, the second portion 86 of the pressure ring 92 may be include (or be formed of) a material having a second coefficient of friction, and the second coefficient of friction may range from about 0.01 to about 0.1. Other ranges are contemplated.

In some embodiments, the first portion 85 and the second portion 86 of the pressure ring 92 may be molded together to form a single-piece integrated seal body 80. In some embodiments, the first portion 85 and the second portion 86 may be co-extruded and formed into the seal body 80 (e.g., a single-piece integrated annular seal body). In some embodiments, the first portion 85 and the second portion 86 may be formed separately and secured to one another to form a single-piece integrated seal body 80. In some embodiments, the first portion 85 and the second portion 86 may be secured to one another via, for example, compression, welding, friction welding, adhesive, and/or mechanical engagement. Other methods of forming the packing assembly seal 78 are contemplated.

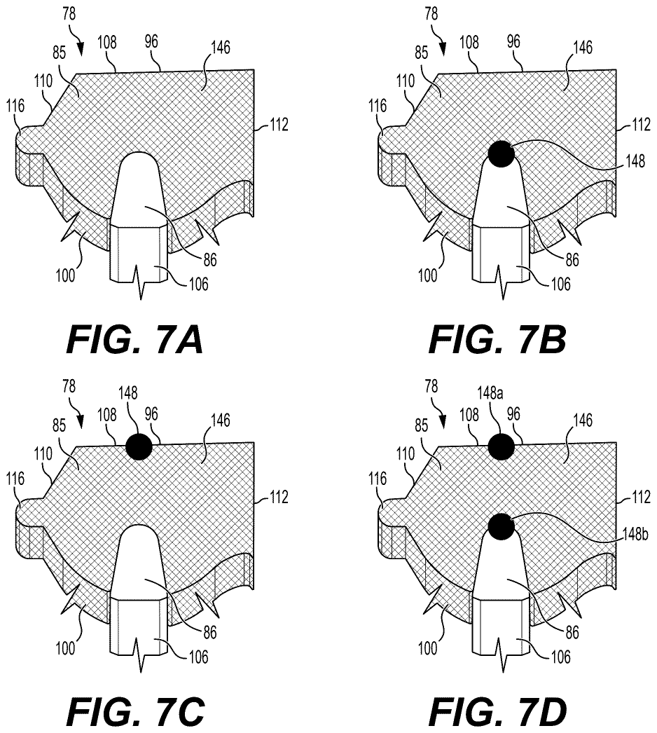

FIG. 7A is a schematic partial cross-section view of another example packing assembly seal 78 (e.g., a header ring 96, as shown, or a pressure ring 92), including an example first portion 85 having example fiber-reinforcement 146, and an example second portion 86, according to embodiments of the disclosure. As schematically depicted in FIG. 7A, in some embodiments, the fiber-reinforcement 146 may be distributed substantially throughout the first portion 85, which may also include sealing material, such as, for example, one or more sealing materials described herein. In some embodiments, for example, the fiber-reinforcement 146 may be distributed substantially homogenously throughout the first portion 85. The fiber-reinforcement 146 may include a plurality of individual fibers substantially evenly distributed throughout the first portion 85. In some embodiments, the fibers may be combined and/or mixed with sealing material and formed into the first portion 85. The sealing material may include any non-fiber materials described herein. In some embodiments, the fiber-reinforcement 146 may include a fabric including fibers, such as, for example, woven fabric including fibers and/or non-woven fabric including fibers, such as, for example, woven mesh and/or non-woven mesh. In some embodiments, fiber-reinforcement 146 may include one or more layers of fabric including fibers, for example, formed into (e.g., molded via pressure and/or heat) the annular form of the packing assembly seal 78. In some embodiments, the fiber-reinforcement 146 may include a combination fabric including fibers and a plurality of individual fibers.

In some embodiments, the fiber-reinforcement 146 may include, for example, a woven metal mesh, a non-woven metal mesh, a metal woven fabric, a metal non-woven fabric, a plurality of layers of metal mesh, a plurality of layers of metal mesh compressed into the seal body (e.g., an annular seal body), a non-woven non-metal mesh, a woven non-metal mesh, a woven non-metal fabric, a non-woven non-metal fabric, fabric-reinforced rubber, aramid-reinforced rubber, fiber-reinforced rubber, carbon fiber-reinforced rubber, cotton fiber-reinforced rubber, polyethylene terephthalate (PET) fiber-reinforced rubber, polyester fiber-reinforced rubber, cotton fibers, aramid fibers, carbon fibers, PET fibers, polyester fibers, and/or a combination thereof. Other materials having similar material characteristics and/or a similar material performance are contemplated.

FIG. 7B is a schematic partial cross-section view of another example packing assembly seal 78 (e.g., a header ring 96, as shown, or a pressure ring 92), including an example first portion 85 having example fiber-reinforcement 146, an example second portion 86, and an example seal energizer 148, according to embodiments of the disclosure. In some embodiments, the seal energizer 148 may be annular and configured and/or positioned to improve the performance of the packing assembly seal 78, such as the effectiveness to maintain a seal in harsh operating conditions, such as, for example, under high pressure and/or under high temperature, among other possible benefits. In some embodiments, the seal energizer 148 may include a spring or an O-ring, for example, as shown in FIG. 7B. Other types of seal energizers are contemplated. As shown in FIG. 7B, in some embodiments, the seal energizer 148 may be positioned between the first portion 85 of the packing assembly seal 78 and the second portion 86 of the packing assembly seal 78. This may enhance or improve the performance of the first portion 85 of the packing assembly seal 78 and/or the second portion 86 of the packing assembly seal 78.

FIG. 7C is a schematic partial cross-section view of a further example packing assembly seal 78 (e.g., a header ring 96, as shown, or a pressure ring 92), including an example first portion 85 having example fiber-reinforcement 146, an example second portion 86, and an example seal energizer 148, according to embodiments of the disclosure. As shown in FIG. 7C, in some embodiments, the seal cross-section may include (a) an inward facing surface 100 (e.g., a radially inward facing surface) at least partially defined by the first portion 85 of the packing assembly seal 78, and (b) an outward facing surface 108 (e.g., a radially outward facing surface) opposite the inward facing surface 100 at least partially defined by the first portion 85 of the packing assembly seal 78. As shown in FIG. 7C, for example, in some embodiments, the seal energizer 148 may be at least partially received in the outward facing surface 108 of the first portion 85. This may enhance or improve the performance of the first portion 85 of the packing assembly seal 78 and/or the second portion 86 of the packing assembly seal 78.

FIG. 7D is a schematic partial cross-section view of yet another example packing assembly seal 78 (e.g., a header ring 96, as shown, or a pressure ring 92), including an example first portion 85 having example fiber-reinforcement 146, an example second portion 86, and example seal energizers 148a and 148b, according to embodiments of the disclosure. As shown, in some embodiments, the packing assembly seal 78 may include a first seal energizer 148a at least partially received in the outward facing surface 108 of the first portion 85 of the packing assembly seal 78. In some embodiments, a second seal energizer 148b may be positioned between the first portion 85 of the packing assembly seal 78 and the second portion 86 of the packing assembly seal 78, for example, as shown. This may improve the performance of the first portion 85 of the packing assembly seal 78 and/or the second portion 86 of the packing assembly seal 78. Additional sealing energizers at different cross-sectional locations of the packing assembly seal 78 are contemplated.

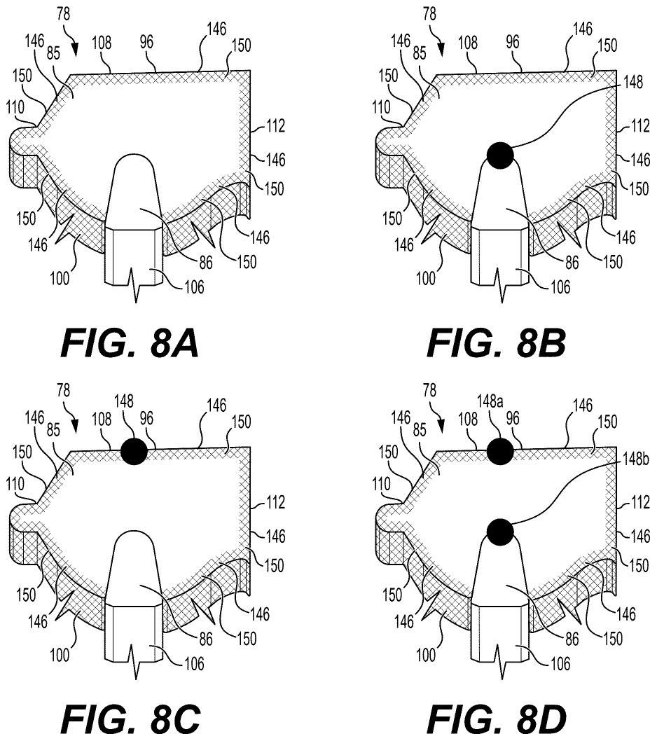

FIG. 8A is a schematic partial cross-section view of another example packing assembly seal 78 (e.g., a header ring 96, as shown, or a pressure ring 92), including an example first portion 85 having a surface 150 with example fiber-reinforcement 146, and an example second portion 86, according to embodiments of the disclosure. In some embodiments consistent with FIGS. 8A-8D, the packing assembly seal 78 may have a seal cross-section including: (a) an inward facing surface 100 (e.g., a radially inward facing surface) at least partially defined by the first portion 85 of the packing assembly seal 78; (b) an outward facing surface 108 (e.g., a radially outward facing surface) opposite the inward facing surface 100; (c) a first axial end surface 110 at least partially defined by the first portion 85; and (d) a second axial end surface 112 substantially opposite the first axial end surface 110. In some embodiments, the second axial end surface 112 may be at least partially defined by the first portion 85. As shown, in some embodiments, the fiber-reinforcement 146 may include one or more fiber-reinforcement layers at least partially covering: (a) the inward facing surface 100; (b) the outward facing surface 108; (c) the first axial end surface 110; and/or (d) the second axial end surface 112. In some embodiments, the one or more fiber-reinforcement layers may include, for example, a woven metal mesh, a non-woven metal mesh, a metal woven fabric, a metal non-woven fabric, a plurality of layers of metal mesh, a plurality of layers of metal mesh compressed into the seal body 80, a non-woven non-metal mesh, a woven non-metal mesh, a woven non-metal fabric, a non-woven non-metal fabric, fabric-reinforced rubber, aramid-reinforced rubber, fiber-reinforced rubber, carbon fiber-reinforced rubber, cotton fiber-reinforced rubber, polyethylene terephthalate (PET) fiber-reinforced rubber, polyester fiber-reinforced rubber, cotton fibers, aramid fibers, carbon fibers, PET fibers, polyester fibers, and/or a combination thereof. Other materials having similar material characteristics and/or a similar material performance are contemplated.

FIG. 8B is a schematic partial cross-section view of another example packing assembly seal 78 (e.g., a header ring 96, as shown, or a pressure ring 92), including an example first portion 85 having a surface 150 with example fiber-reinforcement 146, an example second portion 86, and an example seal energizer 148, according to embodiments of the disclosure. In some embodiments, the seal energizer 148 may be configured and/or positioned to improve the performance of the packing assembly seal 78, such as the effectiveness to maintain a seal in harsh operating conditions, such as, for example, under high pressure and/or under high temperature, among other possible benefits, as described herein. In some embodiments consistent with FIGS. 8B-8D, the seal energizer 148 may include a spring or an O-ring, for example, as shown in FIG. 8B. As shown in FIG. 8B, in some embodiments, the seal energizer 148 may be positioned between the first portion 85 of the packing assembly seal 78 and the second portion 86 of the packing assembly seal 78. This may enhance or improve the performance of the first portion 85 of the packing assembly seal 78 and/or the second portion 86 of the packing assembly seal 78.

FIG. 8C is a schematic partial cross-section view of a further example packing assembly seal 78 (e.g., a header ring 96, as shown, or a pressure ring 92), including an example first portion 85 having a surface 150 with example fiber-reinforcement 146, an example second portion 86, and an example seal energizer 148, according to embodiments of the disclosure. As shown in FIG. 8C, in some embodiments, the seal cross-section may include (a) an inward facing surface 100 at least partially defined by the first portion 85 of the packing assembly seal 78, and (b) an outward facing surface 108 opposite the inward facing surface 100 at least partially defined by the first portion 85 of the packing assembly seal 78. As shown in FIG. 8C, for example, in some embodiments, the seal energizer 148 may be at least partially received in the outward facing surface 108 of the first portion 85. This may improve the performance of the first portion 85 of the packing assembly seal 78 and/or the second portion 86 of the packing assembly seal 78.

FIG. 8D is a schematic partial cross-section view of yet another example packing assembly seal 78 (e.g., a header ring 96, as shown, or a pressure ring 92), including an example first portion 85 having a surface 150 with example fiber-reinforcement 146, an example second portion 86, and example seal energizers 148a and 148b, according to embodiments of the disclosure. As shown, in some embodiments, the packing assembly seal 78 may include a first seal energizer 148a at least partially received in the outward facing surface 108 of the first portion 85 of the packing assembly seal 78. In some embodiments, a second seal energizer 148b may be positioned between the first portion 85 of the packing assembly seal 78 and the second portion 86 of the packing assembly seal 78, for example, as shown. This may improve the performance of the first portion 85 of the packing assembly seal 78 and/or the second portion 86 of the packing assembly seal 78. Additional sealing energizers at different cross-sectional locations of the packing assembly seal 78 are contemplated.

Example methods are described below, according to embodiments of the disclosure. The order in which the method steps are described is not intended to be construed as a limitation, and any number of the described method steps may be combined in any order and/or in parallel to implement the methods.

A method for enhancing a seal (e.g., a fluid seal) between a surface of a first component (e.g., a fluid end block 18, as shown in FIG. 1) of a machine and a surface of a second component (e.g., a plunger 22, as shown in FIG. 1) of the machine (e.g., a high-power pump 10, as shown in FIG. 1), may include positioning a seal (e.g., a packing assembly seal 78) between the surface of the first component and the surface of the second component. The seal may include a seal body 80 having a seal body surface 82 and a seal cross-section 84 at least partially defined by the seal body surface 82, for example, as shown in FIGS. 3A-8D. In some embodiments, the seal body 80 may include (or be formed into) an annular seal body. The seal body 80 may include a first portion 85 including a first material, the first material having a first coefficient of friction. The seal body 80 further may include a second portion 86 including a second material, the second material having a second coefficient of friction less than the first coefficient of friction, thereby to reduce friction at a seal interface 79 (see, e.g., FIGS. 2A and 2C) between the seal 78 and the second component. The method further may include suppressing generation of heat associated with the seal 78 between a first component and a second component. For example, in some embodiments of the method, the suppressing of the generation of heat associated with the seal 78 between the first component and the second component may include suppressing the generation of heat associated with the seal 78 between the first component and the second component, via the second portion 86 of the seal, during operation of the machine as the second component moves relative to the first component, for example, as described herein.

In some embodiments of the method, the positioning of the seal 78 between the surface of the first component and the surface of the second component may include positioning one or more of a header ring 96, a scraper ring, or a pressure ring 92 between the surface of the first component and the surface of the second component, for example, as described herein. In some embodiments, the positioning of the seal 78 between the surface of the first component and the surface of the second component of the machine may include positioning the seal 78 between a stationary component of the pump (e.g., a fluid end block 18) and one of (a) a reciprocating component of the pump (e.g., a plunger 22) or (b) a rotating component of the pump, for example, as described herein. For example, the positioning of the seal 78 may include positioning the seal 78 between a plunger 22 of a pump 10 and a fluid end 12 of the pump 10. For example, the machine may include a hydraulic fracturing pump, as described herein. The positioning of the seal 78 between the surface of the first component and the surface of the second component of the machine may include positioning the seal 78 between a reciprocating rod of the machine and a stationary part of the machine.

In some embodiments of the method, the first portion 85 of the seal 78 may include an inward facing surface 100 (e.g., a radially inward facing surface), and the first portion 85 may at least partially define a recess 102 (e.g., an annular recess) (see, e.g., FIGS. 3A-6C) in the inward facing surface 100 of the first portion 85 of the seal 78. The second portion 86 of the seal 78 may be at least partially received in the recess 102 in the inward facing surface 100 of the first portion 84 of the seal 78. For example, the inward facing surface 100 of the first portion 85 may be substantially convex and may at least partially define a curved surface, and the second portion 86 of the seal 78 may include an inward facing surface 106 (e.g., a radially inward facing surface). In some embodiments, the inward facing surface 106 of the second portion 86 of the seal 78 may project inward relative to the curved surface of the inward facing surface 100 of the first portion 85 of the seal 78.

In some embodiments of the method, for example, as shown in FIGS. 6A-6C, the first portion 85 of the seal 78 (e.g., a pressure ring 92) may include a first axial end surface 110 and a second axial end surface 112 substantially opposite the first axial end surface 110. The second axial end surface 112 may at least partially define an axial recess 102, and the second portion 86 of the seal 78 may be at least partially received in the axial recess 102 in the second axial end surface 112 of the first portion 85 of the seal 78. The second axial end surface 112 of the first portion 85 may be substantially concave and may extend between an inward facing surface 100 of the first portion 85 and an outward facing surface 108 of the first portion 85. The axial recess 102 may be positioned between the inward facing surface 100 of the first portion 85 and the outward facing surface 108 of the first portion 85 of the seal 78. In some embodiments, the second portion 86 of the seal 78 may include a second portion protrusion 132 at least partially received in the axial recess 102 of the first portion 85 of the seal 78, for example, as described herein. In some embodiments, an inward extending arm 134 (e.g., a radially inward extending arm) may be connected to the second portion protrusion 132, and the inward extending arm 134 may be positioned to bias the inward facing surface 100 of the first portion 85 of the seal 78 inward (e.g., radially inward), for example, as described herein with respect to FIGS. 6A-6C. For example, the second axial end surface 112 of the first portion 85 may include an inner ramp surface 136 extending between the axial recess 102 of the first portion 85 and the inward facing surface 100 of the first portion 85. The inner ramp surface 136 may lie at an inner ramp angle IR relative to a radial axis R of the seal 78, for example, as described herein (see, e.g., FIG. 6C). The inward extending arm 134 may at least partially define an inner arm angle IA relative to the radial axis R of the seal 78, and the inner arm angle IA may be less than or equal to the inner ramp angle IR. In some embodiments of the method, the second portion 86 of the seal 78 may further include an outward extending arm 140 (e.g., a radially outward extending arm) connected to the second portion protrusion 132, and the outward extending arm 140 may be positioned to bias the outward facing surface 108 of the first portion 85 of the seal outward (e.g., radially outward).

In some embodiments of the method, the second coefficient of friction may range from about 0.01 to about 0.1, and the first coefficient of friction may range from about 0.11 to about 0.9. In some embodiments, the material of the second portion 86 of the seal 78 may include one or more of polytetrafluoroethylene (PTFE), virgin PTFE, glass-filled PTFE, graphite-filled PTFE, bronze-filled PTFE, moly disulfide-filled PTFE, graphene-filled PTFE, ultra-high-molecular-weight polyethylene (UHMW), UHMW-polyethylene (PE), graphene-filled UHMW, graphene-filled UHMW-PE, carbon nano-tube-filled PTFE, carbon nanotube-filled UHMW, or carbon nanotube-filled UHMW-PE. Other materials having similar material characteristics and/or performance characteristics are contemplated.

In some embodiments of the method, the method further may include transferring, via operation of the machine (e.g., a high-power pump 10), a portion of the second material onto the second component (e.g., the plunger 22). In some embodiments, the transferring of the portion of the second material onto the second component may result in lubricating the seal interface 79, for example, as described herein.

Some embodiments of the method may include incorporating fiber-reinforcement 146 in the first portion 85 of the seal body 80, for example, as shown in FIGS. 7A-8D. For example, the incorporating of fiber-reinforcement 146 in the first portion 85 may include distributing the fiber-reinforcement 146 substantially throughout the first portion 85, for example, as shown in FIGS. 7A-7D. In some embodiments, the fiber-reinforcement 146 may be distributed substantially homogenously throughout the first portion 85. In some embodiments, the incorporating of fiber-reinforcement 146 in the first portion 146 may include incorporating one or more layers of fiber reinforcement 146 (e.g., fiber-reinforced material) in the first portion 85. In some embodiments of the method, the incorporating of fiber-reinforcement 146 in the first portion 85 may include, for example, incorporating in the first portion 85 one or more of: a woven metal mesh, a non-woven metal mesh, a metal woven fabric, a metal non-woven fabric, a plurality of layers of metal mesh, a plurality of layers of metal mesh compressed into the seal body 80 (e.g., into an annular seal body), a non-woven non-metal mesh, a woven non-metal mesh, a woven non-metal fabric, a non-woven non-metal fabric, fabric reinforced rubber, aramid reinforced rubber, fiber reinforced rubber, carbon fiber reinforced rubber, cotton fiber reinforced rubber, polyethylene terephthalate (PET) fiber reinforced rubber, polyester fiber reinforced rubber, cotton fibers, aramid fibers, carbon fibers, PET fibers, or polyester fibers.

In some embodiments of the method, the incorporating of fiber-reinforcement 146 in the first portion 85 of the seal body 80 may include positioning one or more fiber-reinforcement 146 layers at least partially covering one or more of: (a) an inward facing surface 100 at least partially defined by the first portion 85; (b) an outward facing surface 108 at least partially defined by the first portion 85; (c) a first axial end surface 110 at least partially defined by the first portion 85; or (d) a second axial end surface 112 at least partially defined by the first portion 85, for example, as shown in FIGS. 8A-8D.

Some embodiments of the method further may include incorporating one or more seal energizers 148 into the seal body 80, for example, as shown in FIGS. 7B-7D and FIGS. 8B-8D. In some embodiments, the one or more seal energizers 148 may include a spring and/or an O-ring. Other types of seal energizers are contemplated.

In some embodiments of the method, the incorporating of the one or more seal energizers 148 into the seal body 80 may include positioning the one or more seal energizers 148 between the first portion 85 and the second portion 86 of the packing assembly seal 78, for example, as shown in FIGS. 7B and 7D and FIGS. 8B and 8D. In some embodiments of the method, the incorporating of the one or more seal energizers 148 into the seal body 80 may include positioning the one or more seal energizers 148 in the outward facing surface 108 at least partially defined by the first portion 85, for example, as shown in FIGS. 7C and 7D and FIGS. 8C and 8D. In some embodiments, the incorporating of the one or more seal energizers 148 into the seal body 80 may include positioning: (a) a first seal energizer 148a in the outward facing surface 108 at least partially defined by the first portion 85, and (b) a second seal energizer 148b between the first portion 85 and the second portion 86 of the seal body 80, for example as shown in FIGS. 7D and 8D. Other locations in the seal body 80 for the seal energizers are contemplated.

A method for increasing the service life of a seal for providing a seal (e.g., a fluid seal) between a surface of a first component (e.g., a fluid end block 18, as shown in FIG. 1) of a machine and a surface of a second component (e.g., a plunger 22, as shown in FIG. 1) of the machine (e.g., a high-power pump 10, as shown in FIG. 1), may include may include positioning a seal 78 between the surface of the first component and the surface of the second component. The seal 78 may include a seal body 80 having a seal body surface 82 and a seal cross-section 84 at least partially defined by the seal body surface 82. In some embodiments, the seal body 80 may include (or be formed into) an annular seal body. In some embodiments, the seal body 80 may include a first portion 85 including a first material. The first material may have a first coefficient of friction. The seal body 80 further may include a second portion 86 including a second material, and the second material may have a second coefficient of friction less than the first coefficient of friction, thereby to reduce friction at a seal interface 79 between the seal 78 and the second component. The method further may include suppressing generation of heat associated with the seal 78 between the first component and the second component. For example, in some embodiments of the method, the suppressing of the generation of heat associated with the seal 78 between the first component and the second component may include the suppressing of the generation of heat associated with the seal 78 between the first component and the second component, via the second portion 86 of the seal 78, during operation of the machine, as the second component moves relative to the first component, thereby extending the service life of the seal 78, for example, as described herein.

In some embodiments of the method, the positioning of the seal 78 between the surface of the first component and the surface of the second component may include positioning one or more of a header ring 96, a scraper ring, or a pressure ring 92 between the surface of the first component and the surface of the second component. The positioning of the seal 78 between the surface of the first component and the surface of the second component of the machine may include positioning the seal 78 between a stationary component of the pump and one of (a) a reciprocating component of the pump or (b) a rotating component of the pump. For example, in some embodiments, the positioning of the seal 78 may include positioning the seal 78 between a plunger 22 of a pump 10 and a fluid end 12 of the pump 10. In some embodiments, the pump 10 may be a hydraulic fracturing pump. Other types of pumps are contemplated. In some embodiments, the seal 78 may be a packing assembly seal 78. Other types of seals are contemplated. The positioning of the seal 78 between the surface of the first component and the surface of the second component machine may include positioning the seal 78 between a reciprocating rod of the machine and a stationary part of the machine.

A method for enhancing a seal (e.g., a fluid seal) between the surface of a first component of a pump and the surface of a second component of the pump, may include positioning, between the surface of the first component of the pump and the surface of the second component of the pump, a seal 78 having a seal body 80 including a seal body surface 82 and a seal cross-section 84 at least partially defined by the seal body surface 82. In some embodiments, the seal body 80 may include (or be formed into) an annular seal body. The seal body 80 may include a first portion 85 including a first material, and the first material may have a first coefficient of friction. The seal body 80 further may include a second portion 86 including a second material, and the second material may have a second coefficient of friction less than the first coefficient of friction, thereby to reduce friction at a seal interface 79 between the seal 78 and the second component of the pump, so as to reduce heat generation and extend a service life of the seal 78 as the second component of the pump moves relative to the first component, for example, as described herein.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application claims priority to, and the benefit of U.S. Provisional Application No. 63/852,220, filed Jul. 28, 2025, titled “SYSTEMS, ASSEMBLIES, APPARATUSES, AND METHODS PROVIDING ENHANCED FLUID SEAL BETWEEN MACHINE COMPONENTS,” and U.S. Provisional Application No. 63/720,038, filed Nov. 13, 2024, titled “SYSTEMS, ASSEMBLIES, APPARATUSES, AND METHODS PROVIDING ENHANCED FLUID SEAL BETWEEN MACHINE COMPONENTS,” the disclosures of which are incorporated herein by reference in their entirety.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

What is claimed is:

1. A fluid end comprising:
a fluid end block at least partially defining a fluid end bore;
a packing recess associated with the fluid end bore, the packing recess at least partially defining a packing recess bore; and
a packing assembly at least partially received in the packing recess bore, the packing assembly positioned to enhance a seal between the packing recess and a plunger reciprocating relative to the fluid end block, the packing assembly comprising:
(a) a packing assembly seal comprising a seal body having a seal body surface and a seal cross-section at least partially defined by the seal body surface, the seal body comprising:
(i) a first portion including a first material, the first material having a first coefficient of friction,
(ii) a second portion including a second material, the second material having a second coefficient of friction less than the first coefficient of friction, thereby to reduce friction at a seal interface between the packing assembly seal and the plunger, so as to reduce heat generation and extend a service life of the packing assembly seal as the plunger moves relative to the packing recess; and
(b) one or more of:
(i) a lantern ring;
(ii) a lube seal;
(iii) an adaptor ring;
(iv) a pressure ring; or
(v) a junk ring.

2. The fluid end of claim 1, further comprising a packing sleeve at least partially defining the packing recess, the packing sleeve being one of: (a) at least partially received in the fluid end bore, or (b) at least partially received in a packing housing attached to the fluid end block.

3. The fluid end of claim 1, wherein the packing assembly seal comprises one of a header ring, a scraper ring, or a pressure ring.

4. The fluid end of claim 1, wherein:
the packing assembly comprises the pressure ring and the junk ring; and
the packing assembly seal is positioned between the pressure ring and the junk ring.

5. The fluid end of claim 1, wherein one or more of:
(a) the packing assembly includes the lantern ring, and the lantern ring comprises one or more of bronze, aluminum, or brass.
(b) the packing assembly includes the lube seal, and the lube seal comprises one or more of an O-ring seal, natural rubber, synthetic rubber, polymeric material, nitriles, fluorocarbon resins, or silicone resins;
(c) the packing assembly includes the adaptor ring, and the adaptor ring comprises one or more of bronze, aluminum, or brass;
(d) the packing assembly includes the pressure ring, and the pressure ring comprises one or more of fabric, composite, nitrile rubber (HNBR), polytetrafluoroethylene (PTFE), thermoplastic polyurethane (TPU), or RESILON; or
(e) the packing assembly includes the junk ring, and the junk ring comprises one or more of composite, steel, brass, bronze, aluminum, or polyether ether ketone (PEEK).

6. The fluid end of claim 1, wherein the packing assembly seal comprises one of a header ring, a pressure ring, or a scraper ring, and the packing assembly comprises:
(a) the lantern ring;
(b) the lube seal;
(c) the adaptor ring;
(d) the pressure ring; and
(e) a junk ring.

7. The fluid end of claim 6, wherein one or more of:
the one of the header ring, the pressure ring, or the scraper ring is between the junk ring and the pressure ring,
the adaptor ring is between the pressure ring and the lantern ring,
the lube seal is received in a groove of the lantern ring, or
the lube seal is received in a groove in a packing retainer nut.

8. The fluid end of claim 1, wherein:
the first portion includes an inward facing surface;
the first portion at least partially defines a recess in the inward facing surface of the first portion;
the second portion is at least partially received in the recess in the inward facing surface of the first portion;
the inward facing surface of the first portion is substantially convex and at least partially defines a curved surface;
the second portion includes an inward facing surface, the inward facing surface of the second portion projecting inward relative to the curved surface of the inward facing surface of the first portion; and
the inward facing surface of the second portion is positioned at the seal interface between the packing assembly seal and the second component.

9. The fluid end of claim 1, wherein one or more of:
(a) the first coefficient of friction ranges from about 0.11 to about 0.9;
(b) the second coefficient of friction ranges from about 0.01 to about 0.1;
(c) the first material comprises one or more of a woven metal mesh, a non-woven metal mesh, a metal woven fabric, a metal non-woven fabric, a plurality of layers of metal mesh, a plurality of layers of metal mesh compressed into the seal body, a non-woven non-metal mesh, a woven non-metal mesh, a woven non-metal fabric, a non-woven non-metal fabric, polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), thermoplastic polyurethane (TPU), RESILON, or polyurethane; or
(d) the second material comprises one or more of polytetrafluoroethylene (PTFE), virgin PTFE, glass-filled PTFE, graphite-filled PTFE, bronze-filled PTFE, moly disulfide-filled PTFE, graphene-filled PTFE, ultra-high-molecular-weight polyethylene (UHMW), UHMW-polyethylene (PE), graphene-filled UHMW, graphene-filled UHMW-PE, carbon nano-tube-filled PTFE, carbon nanotube-filled UHMW, or carbon nanotube-filled UHMW-PE.

10. The fluid end of claim 1, wherein:
(a) the first portion includes a first axial end surface and a second axial end surface substantially opposite the first axial end surface, the second axial end surface at least partially defining an axial recess;
(b) the second portion is at least partially received in the axial recess in the second axial end surface of the first portion;
(c) the second axial end surface of the first portion is substantially concave and extends between an inward facing surface of the first portion and an outward facing surface of the first portion;
(d) the axial recess is positioned between the inward facing surface of the first portion and the outward facing surface of the first portion; and
(e) the second portion includes:
(i) a second portion protrusion at least partially received in the axial recess of the first portion;
(ii) an inward extending arm connected to the second portion protrusion, the inward extending arm being positioned to bias the inward facing surface of the first portion radially inward; and
(iii) an outward extending arm connected to the second portion protrusion, the outward extending arm is positioned to bias the outward facing surface of the first portion radially outward, wherein:
the second axial end surface of the first portion comprises an inner ramp surface extending between the axial recess of the first portion and the inward facing surface of the first portion, the inner ramp surface lying at an inner ramp angle relative to a radial axis of the packing assembly seal,
the inward extending arm at least partially defines an inner arm angle relative to the radial axis of the packing assembly seal, and
the inner arm angle is less than or equal to the inner ramp angle.

11. The fluid end of claim 1, wherein:
(a) the packing assembly seal comprises a first seal ring and a second seal ring;
(b) the first seal ring comprises:
a first annular seal body having a first seal body surface and a first seal cross-section at least partially defined by the first seal body surface, the first annular seal body comprising:
(i) a first portion including a first material, the first material having a first coefficient of friction; and
(ii) a second portion including a second material, the second material having a second coefficient of friction less than the first coefficient of friction, thereby to reduce friction at a seal interface between the first seal ring and the second component, so as to reduce heat generation and extend a service life of the first seal ring as the second component moves relative to the first component, the first component comprising a stationary component relative to the second component during operation of the fluid end, and the second component comprising one of a reciprocating component or a rotating component relative to the first component during operation of the fluid end,
the first portion including an inward facing surface,
the first portion at least partially defining a recess in the inward facing surface of the first portion, and
the second portion being at least partially received in the recess in the inward facing surface of the first portion; and
(c) the second seal ring comprises:
a second annular seal body having a second seal body surface and a second seal cross-section at least partially defined by the second seal body surface, the second annular seal body comprising:
(i) a third portion including a third material, the third material having a third coefficient of friction; and
(ii) a fourth portion including a fourth material, the fourth material having a fourth coefficient of friction less than the third coefficient of friction, thereby to reduce friction at a second seal interface between the second seal ring and the second component, so as to reduce heat generation and extend a service life of the second seal ring as the second component moves relative to the first component.

12. The fluid end of claim 11, wherein:
the first seal ring comprises a header ring;
the second seal ring comprises a first pressure ring; and
the packing assembly seal further comprises a second pressure ring between the header ring and the first pressure ring.

13. A packing assembly to enhance a seal between a surface of a first component of a fluid end and a surface of a second component of the fluid end, the packing assembly comprising:
(a) a packing assembly seal comprising a seal body having a seal body surface and a seal cross-section at least partially defined by the seal body surface, the packing assembly seal comprising one of a header ring, a pressure ring, or a scraper ring, and the seal body having:
(i) a first portion including a first material, the first material having a first coefficient of friction; and
(ii) a second portion including a second material, the second material having a second coefficient of friction less than the first coefficient of friction, thereby to reduce friction at a seal interface between the packing assembly seal and the second component, so as to reduce heat generation and extend a service life of the packing assembly seal as the second component moves relative to the first component, the first component comprising a stationary component relative to the second component during operation of the fluid end, and the second component comprising one of a reciprocating component or a rotating component relative to the first component during operation of the fluid end; and
(b) one or more of:
(i) a lantern ring;
(ii) a lube seal;
(iii) an adaptor ring;
(iv) a pressure ring; or
(v) a junk ring.

14. The packing assembly of claim 13, wherein one or more of:
(a) the packing assembly includes the lantern ring, and the lantern ring comprises one or more of bronze, aluminum, or brass;
(b) the packing assembly includes the lube seal, and the lube seal comprises one or more of an O-ring seal, natural rubber, synthetic rubber, polymeric material, nitriles, fluorocarbon resins, or silicone resins;
(c) the packing assembly includes the adaptor ring, and the adaptor ring comprises one or more of bronze, aluminum, or brass;
(d) the packing assembly includes the pressure ring, and the pressure ring comprises one or more of fabric, composite, nitrile rubber (HNBR), polytetrafluoroethylene (PTFE), thermoplastic polyurethane (TPU), or RESILON; or
(e) the packing assembly includes the junk ring, and the junk ring comprises one or more of composite, steel, brass, bronze, aluminum, or polyether ether ketone (PEEK).

15. The packing assembly of claim 13, wherein the packing assembly seal comprises one of a header ring or a scraper ring, and the packing assembly comprises:
(a) the lantern ring;
(b) the lube seal;
(c) the adaptor ring;
(d) the pressure ring; and
(e) a junk ring, wherein one or more of:
(i) the one of the header ring or the scraper ring is between the junk ring and the pressure ring,
(ii) the adaptor ring is between the pressure ring and the lantern ring,
(iii) the lube seal is received in a groove of the lantern ring, or
(iv) the lube seal is received in a groove in a packing retainer nut.

16. The packing assembly of claim 13, wherein:
the first portion includes an inward facing surface;
the first portion at least partially defines a recess in the inward facing surface of the first portion;
the second portion is at least partially received in the recess in the inward facing surface of the first portion;
the inward facing surface of the first portion is substantially convex and at least partially defines a curved surface;
the second portion includes an inward facing surface, the inward facing surface of the second portion projecting inward relative to the curved surface of the inward facing surface of the first portion; and
the inward facing surface of the second portion is positioned at the seal interface between the packing assembly seal and the second component.

17. The packing assembly of claim 13, wherein one or more of:
(a) the first coefficient of friction ranges from about 0.11 to about 0.9;
(b) the second coefficient of friction ranges from about 0.01 to about 0.1;
(c) the first material comprises one or more of a woven metal mesh, a non-woven metal mesh, a metal woven fabric, a metal non-woven fabric, a plurality of layers of metal mesh, a plurality of layers of metal mesh compressed into the seal body, a non-woven non-metal mesh, a woven non-metal mesh, a woven non-metal fabric, a non-woven non-metal fabric, polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), thermoplastic polyurethane (TPU), RESILON, or polyurethane; or
(d) the second material comprises one or more of polytetrafluoroethylene (PTFE), virgin PTFE, glass-filled PTFE, graphite-filled PTFE, bronze-filled PTFE, moly disulfide-filled PTFE, graphene-filled PTFE, ultra-high-molecular-weight polyethylene (UHMW), UHMW-polyethylene (PE), graphene-filled UHMW, graphene-filled UHMW-PE, carbon nano-tube-filled PTFE, carbon nanotube-filled UHMW, or carbon nanotube-filled UHMW-PE.

18. The packing assembly of claim 13, wherein:
(a) the first portion includes a first axial end surface and a second axial end surface substantially opposite the first axial end surface, the second axial end surface at least partially defining an axial recess;
(b) the second portion is at least partially received in the axial recess in the second axial end surface of the first portion;
(c) the second axial end surface of the first portion is substantially concave and extends between an inward facing surface of the first portion and an outward facing surface of the first portion;
(d) the axial recess is positioned between the inward facing surface of the first portion and the outward facing surface of the first portion; or
(e) the second portion includes:
(i) a second portion protrusion at least partially received in the axial recess of the first portion,
(ii) an inward extending arm connected to the second portion protrusion, the inward extending arm being positioned to bias the inward facing surface of the first portion radially inward, and
(iii) an outward extending arm connected to the second portion protrusion, the outward extending arm is positioned to bias the outward facing surface of the first portion radially outward, wherein:
the second axial end surface of the first portion comprises an inner ramp surface extending between the axial recess of the first portion and the inward facing surface of the first portion, the inner ramp surface lying at an inner ramp angle relative to a radial axis of the packing assembly seal,
the inward extending arm at least partially defines an inner arm angle relative to the radial axis of the packing assembly seal, and
the inner arm angle is less than or equal to the inner ramp angle.

19. The packing assembly of claim 13, wherein:
(a) the packing assembly seal comprises a first seal ring and a second seal ring;
(b) the first seal ring comprises:
a first annular seal body having a first seal body surface and a first seal cross-section at least partially defined by the first seal body surface, the first annular seal body comprising:
(i) a first portion including a first material, the first material having a first coefficient of friction; and
(ii) a second portion including a second material, the second material having a second coefficient of friction less than the first coefficient of friction, thereby to reduce friction at a seal interface between the first seal ring and the second component, so as to reduce heat generation and extend a service life of the first seal ring as the second component moves relative to the first component, the first component comprising a stationary component relative to the second component during operation of the fluid end, and the second component comprising one of a reciprocating component or a rotating component relative to the first component during operation of the fluid end,
the first portion including an inward facing surface,
the first portion at least partially defining a recess in the inward facing surface of the first portion, and
the second portion being at least partially received in the recess in the inward facing surface of the first portion; and
(c) the second seal ring comprises:
a second annular seal body having a second seal body surface and a second seal cross-section at least partially defined by the second seal body surface, the second annular seal body comprising:
(i) a third portion including a third material, the third material having a third coefficient of friction; and
(ii) a fourth portion including a fourth material, the fourth material having a fourth coefficient of friction less than the third coefficient of friction, thereby to reduce friction at a second seal interface between the second seal ring and the second component, so as to reduce heat generation and extend a service life of the second seal ring as the second component moves relative to the first component.

20. The packing assembly of claim 19, wherein:
the first seal ring comprises a header ring;
the second seal ring comprises a first pressure ring; and
the packing assembly seal further comprises a second pressure ring between the header ring and the first pressure ring.

21. A packing assembly seal to enhance a seal between a surface of a first component of a fluid end and a surface of a second component of the fluid end, the packing assembly seal comprising:
a seal body having a seal body surface and a seal cross-section at least partially defined by the seal body surface, the seal body comprising:
(a) a first portion including a first material, the first material having a first coefficient of friction; and
(b) a second portion including a second material, the second material having a second coefficient of friction less than the first coefficient of friction, thereby to reduce friction at a seal interface between the packing assembly seal and the second component, so as to reduce heat generation and extend a service life of the packing assembly seal as the second component moves relative to the first component, the first component comprising a stationary component relative to the second component during operation of the fluid end, and the second component comprising one of a reciprocating component or a rotating component relative to the first component during operation of the fluid end.

22. The packing assembly seal of claim 21, wherein:
the first portion includes an inward facing surface;
the first portion at least partially defines a recess in the inward facing surface of the first portion; and
the second portion is at least partially received in the recess in the inward facing surface of the first portion.

23. The packing assembly seal of claim 22, wherein:
the inward facing surface of the first portion is substantially convex and at least partially defines a curved surface;
the second portion includes an inward facing surface, the inward facing surface of the second portion projecting inward relative to the curved surface of the inward facing surface of the first portion; and
the second portion includes an inward facing surface, and the inward facing surface of the second portion is positioned at the seal interface between the packing assembly seal and the second component.

24. The packing assembly seal of claim 21, wherein one or more of:
(a) the first coefficient of friction ranges from about 0.11 to about 0.9;
(b) the second coefficient of friction ranges from about 0.01 to about 0.1;
(c) the first material comprises one or more of a woven metal mesh, a non-woven metal mesh, a metal woven fabric, a metal non-woven fabric, a plurality of layers of metal mesh, a plurality of layers of metal mesh compressed into the seal body, a non-woven non-metal mesh, a woven non-metal mesh, a woven non-metal fabric, a non-woven non-metal fabric, polymers, thermoplastic polymers, thermosetting polymers, elastomeric polymers, elastomers, thermoplastics, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), thermoplastic polyurethane (TPU), RESILON, or polyurethane; or
(d) the second material comprises one or more of polytetrafluoroethylene (PTFE), virgin PTFE, glass-filled PTFE, graphite-filled PTFE, bronze-filled PTFE, moly disulfide-filled PTFE, graphene-filled PTFE, ultra-high-molecular-weight polyethylene (UHMW), UHMW-polyethylene (PE), graphene-filled UHMW, graphene-filled UHMW-PE, carbon nano-tube-filled PTFE, carbon nanotube-filled UHMW, or carbon nanotube-filled UHMW-PE.

25. The packing assembly seal of claim 21, wherein:
(a) the first portion includes a first axial end surface and a second axial end surface substantially opposite the first axial end surface, the second axial end surface at least partially defining an axial recess;
(b) the second portion is at least partially received in the axial recess in the second axial end surface of the first portion;
(c) the second axial end surface of the first portion is substantially concave and extends between an inward facing surface of the first portion and an outward facing surface of the first portion;
(d) the axial recess is positioned between the inward facing surface of the first portion and the outward facing surface of the first portion; and
(e) the second portion includes:
(i) a second portion protrusion at least partially received in the axial recess of the first portion;
(ii) an inward extending arm connected to the second portion protrusion, the inward extending arm being positioned to bias the inward facing surface of the first portion radially inward; and
(iii) an outward extending arm connected to the second portion protrusion, the outward extending arm is positioned to bias the outward facing surface of the first portion radially outward, wherein:
the second axial end surface of the first portion comprises an inner ramp surface extending between the axial recess of the first portion and the inward facing surface of the first portion, the inner ramp surface lying at an inner ramp angle relative to a radial axis of the packing assembly seal,
the inward extending arm at least partially defines an inner arm angle relative to the radial axis of the packing assembly seal, and
the inner arm angle is less than or equal to the inner ramp angle.

26. The packing assembly seal of claim 21, wherein:
(a) the packing assembly seal comprises a first seal ring and a second seal ring;
(b) the first seal ring comprises:
a first annular seal body having a first seal body surface and a first seal cross-section at least partially defined by the first seal body surface, the first annular seal body comprising:
(i) a first portion including a first material, the first material having a first coefficient of friction; and
(ii) a second portion including a second material, the second material having a second coefficient of friction less than the first coefficient of friction, thereby to reduce friction at a seal interface between the first seal ring and the second component, so as to reduce heat generation and extend a service life of the first seal ring as the second component moves relative to the first component, the first component comprising a stationary component relative to the second component during operation of the fluid end, and the second component comprising one of a reciprocating component or a rotating component relative to the first component during operation of the fluid end,
the first portion including an inward facing surface,
the first portion at least partially defining a recess in the inward facing surface of the first portion, and
the second portion being at least partially received in the recess in the inward facing surface of the first portion; and
(c) the second seal ring comprises:
a second annular seal body having a second seal body surface and a second seal cross-section at least partially defined by the second seal body surface, the second annular seal body comprising:
(i) a third portion including a third material, the third material having a third coefficient of friction; and
(ii) a fourth portion including a fourth material, the fourth material having a fourth coefficient of friction less than the third coefficient of friction, thereby to reduce friction at a second seal interface between the second seal ring and the second component, so as to reduce heat generation and extend a service life of the second seal ring as the second component moves relative to the first component.

27. The packing assembly seal of claim 26, wherein:
the first seal ring comprises a header ring;
the second seal ring comprises a first pressure ring; and
the packing assembly seal further comprises a second pressure ring between the header ring and the first pressure ring.

28. A method for enhancing a seal between a surface of a first component of a fluid end and a surface of a second component of the fluid end, the method comprising:
(a) positioning a seal between the surface of the first component and the surface of the second component, the seal having a seal body having a seal body surface and a seal cross-section at least partially defined by the seal body surface, the seal body comprising:
(i) a first portion including a first material, the first material having a first coefficient of friction; and
(ii) a second portion including a second material, the second material having a second coefficient of friction less than the first coefficient of friction, thereby to reduce friction at a seal interface between the seal and the second component; and
(b) suppressing generation of heat associated with the seal between the first component and the second component, via the second portion of the seal, during operation of the fluid end as the second component moves relative to the first component.

29. The method of claim 28, wherein the positioning of the seal between the surface of the first component and the surface of the second component comprises positioning the seal between a stationary component of the fluid end and one of (a) a reciprocating component of the fluid end or (b) a rotating component of the fluid end.

30. The method of claim 28, further comprising transferring, via operation of the fluid end, a portion of the second material onto the second component, the transferring of the portion of the second material onto the second component comprising lubricating the seal interface.
